(19) United States
(12) Patent Application Publication
(10) Pub. No.: US 2006/0186224 A1
(43) Pub. Date: Aug. 24, 2006

(54) Vehicle air conditioner

(75) Inventors: Kenichi Yoshii, Nagoya-city (JP); Kazuhiro Fukuta, Nagoya-city (JP); Kazuhisa Makida, Handa-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/351,178

(22) Filed: Feb. 9, 2006

(30) Foreign Application Priority Data
Feb. 22, 2005 (JP) 2005-045500
Dec. 8, 2005 (JP) 2005-354678

(51) Int. Cl. A62C 31/00; B05B 1/14; A62C 2/08

(52) U.S. Cl. 239/436; 239/548

(57) ABSTRACT

A vehicle air conditioner is disclosed. Internal air paths and external air paths are arranged in parallel to each other, and the internal air and the external air are blown by a blower to the internal and external air paths. Heat exchangers are arranged in at least the internal air paths, and the internal air after passing through the heat exchangers are blown toward the passenger in the cabin from a face air outlet and a foot air outlet on the one hand and toward the wind shield in the cabin from a wind shield defroster air outlet. Also, the external air passed through the external air paths is blown toward the door window glass in the cabin from door defroster air outlets.

### BACKGROUND OF THE INVENTION

1. Field of the Invention

This invention relates to a vehicle air conditioner suitably applicable to a vehicle such an agricultural tractor used in a dusty diary farming, grain growing, etc environment.

2. Description of the Related Art

In a conventional vehicle used in a dusty environment, such as an agricultural tractor, an air conditioner, even when operated in internal air mode, introduces external air into the cabin through a filter by an external air introduction mechanism and, by thus increasing the internal pressure of the cabin, the intrusion of dust into the cabin is suppressed (for example, Japanese Unexamined Patent Publication No. 10-147128, U.S. Pat. No. 5,119,718).

In the prior art described above, however, the external air introduced by the external air introduction mechanism is mixed with the internal air, and this mixed air is applied to a cooling heat exchanger or a heating heat-exchanger to exchange heat, and the air (cool air or warm air) obtained by this heat exchange operation is blown into the cabin.

During a season high in temperature and humidity, therefore, air mixed with air high in temperature and humidity is required to be cooled by the cooling heat exchanger, and the resulting increased cooling load makes it impossible to sufficiently reduce the temperature of the air blown into the cabin, thereby extremely deteriorating the cooling performance. At the same time, a problem is posed that the power consumption of the compressor for circulating the refrigerant through the cooling heat exchanger (evaporator) is increased.

During the winter season when the external air is low in temperature, on the other hand, the air mixed with the external air low in temperature is required to be heated by the heating heat exchanger, and the heating load is greatly increased. Therefore, the temperature of the air blown into the cabin cannot be sufficiently increased, thereby greatly deteriorating the heating performance and the defroster performance.

In order to obviate this problem of performance deterioration, the size of the cooling heat exchanger or the heating heat exchanger, as the case may be, may be increased. In such a case, however, the internal space in the cabin in which the air conditioner is installed is increased and the comfort of the passenger is adversely affected.

### SUMMARY OF THE INVENTION

In view of the problem described above, the object of this invention is to secure a function of suppressing the intrusion of dust into the cabin on the one hand and to secure an air-conditioning performance at the same time.

In order to accomplish the above object, according to a first aspect of the present invention, there is provided a vehicle air conditioner comprising:

internal air paths (27, 48) through which an internal air flows into a cabin;

external air paths (28, 49) arranged in parallel to the internal air paths (27, 48) and through which an external air flows into the cabin;

heat exchangers (29, 31) arranged in at least the internal air paths (27, 48) to exchange heat with at least the internal air;

a blowing means (30) for blowing the internal air in the internal air paths (27, 48) and the external air in the external air paths (28, 49);

first air outlets (57a, 57b, 58) for blowing the internal air after passing through the heat exchangers (29, 31) toward the passenger in the cabin;

second air outlets (60) for blowing out the external air after passing through the external air paths (28, 49) toward parts other than the passenger and the wind shield (12) in the cabin; and

a third air outlet (59) for blowing the internal air after passing through the heat exchangers (29, 31) toward the wind shield (12) in the cabin.

According to this invention, the internal air and the external air can be introduced into the cabin in parallel and, therefore, heat exchangers (29, 31) can exchange heat with the internal air separated from the external air flow. As a result, the heat load of the heat exchangers (29, 31) is reduced. During the cooling operation, therefore, the temperature of the cool air blown toward the passenger from first air outlets (57a, 57b, 58) can be reduced. Similarly, during the heating operation, the temperature of the warm air blown toward the passenger from the first air outlets (57a, 57b, 58) can be increased. Thus, the cabin cooling and heating performance can be improved without increasing the size of the heat exchangers (29, 31). Also, the reduction in the cooling heat load can reduce the power consumption of the compressor in the refrigeration cycle.

Further, by introducing the external air from second air outlets (60) through external air paths (28, 49) into the cabin, the internal pressure of the cabin is increased and a function of suppressing the dust intrusion into the cabin can be exhibited. The air from the second air outlets (60) is blown toward other parts than the passenger except for the wind shield (12) in the cabin and not blown directly to the passenger. Even in the case where the external air blown from the second air outlets (60) is not regulated to a comfortable temperature range, therefore, the passenger feels no discomfort regarding the climate.

The internal air passed through the heat exchangers (29, 31) is blown toward the wind shield (12) in the cabin from a third air outlet (59). During the cold season when the wind shield (12) is decreased in temperature and liable to be frosted, therefore, the internal warm air heated by the heat exchangers (29, 31) is blown to the wind shield (12) and thus can defog it.

Specifically, the internal air, though higher in absolute temperature than the external temperature, is recirculated and heated by the heat exchangers (39, 31), and therefore the temperature of the internal air from the third air outlet (59) can be increased sufficiently. Thus, the relative humidity of the warm internal air can be reduced.

The agricultural tractor runs at a very low speed as compared with ordinary cars, and therefore the wind shield (12) is not reduced in temperature by the wind against the vehicle while running. In other words, under the same atmospheric conditions, the wind shield of the agricultural tractor is higher in temperature than that of ordinary cars. Further, the cabin of the agricultural tractor is always occupied by one person, and therefore less moisture is generated by respiration of the passenger than in ordinary cars.

These conditions together make it possible to defog the wind shield (12) of the cabin (10) by increasing the temperature of the internal warm air.

According to a second aspect of the present invention, the second air outlets (60) is concretely constituted to blow out the external air toward the door window glass (13) in the cabin.

As a result, the external air is not directly blown to the passenger, and therefore the ill feeling of the passenger against the climate can be positively suppressed. By blowing the external air toward the door window glass (13) in the cabin, on the other hand, the door window glass (13) can be effectively defogged.

In this connection, according to a third aspect of the present invention, the second air outlets (60) may be constituted to blow out the external air toward the floor surface in the cabin.

According to a fourth aspect of the present invention, the heat exchangers include the cooling heat exchanger (29) for cooling the air.

According to a fifth aspect of the present invention, a vehicle air conditioner comprises:

internal air paths (27, 48) through which an internal air flows into a cabin;

external air paths (28, 49) arranged in parallel to the internal air paths (27, 48) and through which an external air flows into the cabin;

a cooling heat exchanger (29) arranged in at least the internal air paths (27, 48) to exchange heat with at least the internal air;

a blowing means (30) for blowing the internal air of the internal air paths (27, 48) and the external air of the external air paths (28, 49);

first air outlets (57a, 57b, 58) for blowing the internal air after passing through the cooling heat exchanger (29) toward the passenger in the cabin; and

second air outlets (60) for blowing out the external air after passing through the external air paths (28, 49) toward the parts other than the passenger in the cabin;

wherein the blowing means (30) is arranged downstream of the cooling heat exchanger (29) in the air flow.

In view of the fact that the internal air and the external air can be introduced into the cabin in parallel to each other, the cooling heat exchanger (29) can exchange heat with the internal air separated from the external air flow. As a result, the heat load of the cooling heat exchanger (29) can be reduced and, therefore, the temperature of the cool air blown toward the passenger from the first air outlets (57a, 57b, 58) during the cooling operation can be reduced. Thus, the cabin cooling performance is improved without increasing the size of the cooling heat exchanger (29).

In addition, the external air passed through the external air paths (28, 49) is introduced into the cabin from a second air outlets (60) and, by thus increasing the internal pressure of the cabin, the intrusion of dust into the cabin can be suppressed. The air from the second air outlets (60) is blown toward the parts other than the passenger in the cabin but not directly to the passenger. Even in the case where the external air blown out of the second air outlets (60) is higher in temperature than a low comfortable temperature range, therefore, the feeling of the passenger against the climate cannot be adversely affected.

In the vehicle like the agricultural tractor used in a dusty environment, dust is attached to the small fin gaps of the core of the cooling heat exchanger (29) and the core is liable to be clogged. According to the fifth aspect of the invention, however, a blowing means (30) is arranged downstream of the cooling heat exchanger (29) in the air flow, and therefore only ducts are arranged upstream of the cooling heat exchanger (29) in the air flow. Therefore, the cooling heat exchanger (29) can be cleaned to remove dust or mounted or demounted easily just by removing the ducts.

Further, according to the fifth aspect of the invention, the cooling heat exchanger (29) can be accommodated in the internal air path (27) formed upstream of the blowing means (30) and, therefore, the air-conditioning unit (18) having the cooling heat exchanger (29) and the blowing means (30) built therein can be formed in a compact body along the direction of air flow (longitudinal direction of the vehicle in FIG. 3).

According to a sixth aspect of the present invention, the cooling heat exchanger (29) is arranged over the whole area of the internal air paths (27, 48), wherein the external air paths (28, 49) make up bypasses of the cooling heat exchanger (29).

According to the invention, the external air can be introduced bypassing the cooling heat exchanger (29), and therefore the internal air blown toward the passenger from the first air outlets (57a, 57b, 58) can be effectively cooled by the cooling performance of the cooling heat exchanger (29).

According to a seventh aspect of the invention, there is provided a vehicle air conditioner of the sixth aspect, wherein the cooling heat exchanger (29) is arranged only in the internal air paths (27, 48), and the whole area of the external air paths (28, 49) is formed as a bypass for the cooling heat exchanger (29). Thus, the cooling operation of the cooling heat exchanger (29) can be performed exclusively for cooling the internal air, and therefore the cooling heat load is further reduced.

As a result, the temperature of the cool internal air blown toward the passenger from the first air outlets (57a, 57b, 58) can be further reduced, while at the same time further reducing the power consumption of the compressor in the refrigeration cycle.

According to an eighth aspect of the present invention, the cooling heat exchanger (29) is arranged over the internal air paths (27, 48) and the external air paths (28, 49).

Also, in view of the fact that the internal air and the external air can both be cooled by the cooling heat exchanger (29), the temperature of not only the air (internal air) blown out from the first air outlets (57a, 57b, 58) but also the air (external air) blown out from the second air outlets (60) can be reduced. As a result, the whole cabin interior is reduced in temperature and can be cooled more effectively.

According to a ninth aspect of the present invention, the heat exchangers include a heating heat exchanger (31) arranged over both the internal air paths (27, 48) and the external air paths (28, 49) for heating the air.

According to this invention, the warm air heated by the heating heat exchanger (31) is blown out from both the first air outlets (57a, 57b, 58) and the second air outlets (60), and the room temperature of the whole cabin interior is increased. Thus, the whole cabin interior is effectively heated while at the same time effectively defogging the window glass.

According to a tenth aspect of the present invention, the heating heat exchanger (31) may be arranged over the entire area of the internal air paths (27, 48) and a part of the external air paths (28, 49), and wherein the remaining area of the external air paths (28, 49) may make up a bypass (49a) of the heating heat exchanger (31).

According to an eleventh aspect of the present invention, the heating heat exchanger (31) may be arranged over the entire area of the internal air paths (27, 48) and over the entire area of the external air paths (28, 49).

According to a twelfth aspect of the present invention, the heat exchangers may include a heating heat exchanger (31) arranged in both the internal air paths (27, 48) and the external air paths (28, 49) downstream of the blowing means (30) in the air flow.

According to a thirteenth aspect of the present invention, a vehicle air conditioner comprises:

internal air paths (27, 48) through which an internal air flows into a cabin;

external air paths (28, 49) arranged in parallel to the internal air paths (27, 48) and through which an external air flows into the cabin;

heat exchangers (29, 31) arranged in at least the internal air paths (27, 48) to exchange heat with at least the internal air;

a blowing means (30) for blowing the internal air of the internal air paths (27, 48) and the external air of the external air paths (28, 49);

first air outlets (57a, 57b, 58) for blowing the internal air after passing through the heat exchangers (29, 31) toward the passenger in the cabin; and

second air outlets (60) for blowing out the external air after passing through the external air paths (28, 49) toward the parts other than the passenger in the cabin;

wherein the external air paths (28, 49) make up bypasses for the heat exchangers (29, 31).

According to this invention, the external air in the external air paths (28, 49) flows bypassing the heat exchangers (29, 31), and therefore the increase in the heat exchange load by the external air can be positively suppressed. Also, the internal pressure of the cabin is increased by introducing the external air, so that the intrusion of dust into the cabin is suppressed.

Also, as the external air is blown to the parts other than the passenger in the cabin, the discomfort which otherwise might be caused by introduction of the external air can be suppressed without adjusting the temperature of the external air in the comfortable range.

According to a fourteenth aspect of the present invention, the internal air paths (27, 48) are arranged at the transverse central portion of the vehicle, and wherein the external air paths (28, 49) are arranged on the left and right sides of the internal air paths (27, 48).

In the vehicle like the agricultural tractor used in a dusty environment, the ceiling of the cabin (10) is comparatively free of dust, and therefore external air inlets (21) for introducing the external air are desirably arranged on the ceiling. In such a case, external air ducts (22) connected to the external air inlets (21) are suspended from the ceiling along the body frame at the left and right transverse corners of the cabin (10). By arranging the external air paths (28, 49) on both left and right transverse sides of the internal air paths (28, 49), the left and right external air ducts (22) can be easily connected to the left and right external air paths (28, 49).

According to a fifteenth aspect of the present invention, an air-conditioning unit (18), having built therein the internal air paths (27, 48), the external air paths (28, 49), the heat exchangers (29, 31) and the blowing means (30), is arranged under the seat (17) in the cabin. Thus, it can be effectively prevented to adversely affect the comfort of the passenger due to installation of the air-conditioning unit (18).

According to a sixteenth aspect of the present invention, a vehicle air conditioner comprises:

an internal air blowing means (75) for blowing an internal air;

an external air blowing means (80) arranged independently of the internal air blowing means (75) for blowing an external air;

internal air paths (76, 135) in which the internal air blown by the internal air blowing means (75) always flows;

external air paths (81, 136) in which the external air blown by the external air blowing means (80) always flows;

heat exchangers (78, 79, 83, 84, 132, 133) arranged in both the internal air paths (76, 135) and the external air paths (81, 136) to exchange heat with the external air and the internal air;

first air outlets (98a, etc.) arranged at the downstream end of the internal air paths (76, 135). for blowing the internal air after passing through the heat exchangers (78, etc.) toward the passenger in the cabin; and

second air outlets (99a, etc.) arranged at the downstream end of the external paths (81, 136) to blow the external air after passing through the heat exchangers (78, etc.) toward parts other than the passenger in the cabin.

According to this invention, the internal pressure of the cabin is increased by the external air blown from the second air outlets (99a, etc.) and the intrusion of dust into the cabin can be suppressed. Further, as the external air is blown to the parts other than the passenger in the cabin from the second air outlets (99a, etc.), the ill feeling which otherwise might be caused by introduction of the external air can be suppressed without regulating the temperature of the external air in the comfortable temperature range.

Furthermore, an internal air blowing means (75) for blowing the internal air and an external air blowing means (80) for blowing the external air are arranged independently of each other, and so are the internal air paths (76, 135) in which the internal air always flows and the external air paths (81, 136) in which the external air always flows. Therefore, the amount of the internal air blown into the cabin and the amount of the external air blown into the cabin can be controlled independently of each other.

In addition, the independent arrangement of the blowing means (75), (80) and the paths (76, 135), (81, 136) leads to the advantage that the positions of the inlets and outlets of the internal and external airs can be set independently of each other, thereby increasing the design freedom.

According to a seventeenth aspect of the present invention, a vehicle air conditioner further comprises a control means (104) for controlling the air amounts of the internal air blowing means (75) and the external air blowing means (80) independently of each other.

According to this invention, the amount of the internal air blown into the cabin and the amount of the external air blown into the cabin can be automatically controlled independently of each other by a control means (104) in accordance with the liking of the passenger and the environmental conditions of the vehicle.

According to an eighteenth aspect of the present invention, the internal air blowing means (75) and the external air blowing means (80) are centrifugal blowing means, and wherein the centrifugal internal air blowing means (75) and the centrifugal external air blowing means (80) are formed symmetrically with each other with the air outlets thereof arranged in directions opposite to each other, and are connected to the internal paths (76, 135) and the external paths (81, 136), respectively.

As described above, the centrifugal internal air blowing means (75) and the centrifugal external air blowing means (80) are configured symmetrically with each other, and therefore, can share the parts of the blowing means (75, 80) with each other.

According to a nineteenth aspect of the present invention, the internal air paths (76, 135) and the external air paths (81, 136) are formed in different cases (77, 82) independent of each other, and wherein the heat exchangers (78, etc.) include the internal air heat exchangers (78, 79) and the external air heat exchangers (83, 84) accommodated in the independent different cases (77, 82), respectively.

As a result, the heat exchangers for internal and external airs, as well as the blowing means, can be respectively configured as an independent unit.

According to a twentieth aspect of the present invention, the internal air heat exchangers include at least an internal air heating heat exchanger (79) for heating the air and the external air heat exchangers include at least an external air heating heat exchanger (84) for heating the air; and wherein the internal air heating heat exchanger (79) and the external air heating heat exchanger (84) include an internal air heating capacity regulation means (90) and an external air heating capacity regulation means (91), respectively, independently of each other.

Also, by adjusting the internal air heating capacity and the external air heating capacity independently of each other, the temperature of the internal and external airs blown out can be regulated independently of each other.

According to a twenty-first aspect of the present invention, the internal air path (135) and the external air path (136) are formed by being partitioned by a partitioning plate (134) in a common case (131), and wherein the heat exchangers (132, 133) constitute an integral structure arranged over the internal air path (135) and the external air path (136) in the internal space of the common case (131).

According to this invention, the internal air path (135) and the external air path (136) can be accommodated in a common case (131) on the one hand, and the heat exchangers (132, 133) are arranged as an integral structure on the internal and external air sides, respectively, on the other hand. Thus, the number of parts used is reduced.

According to a twenty-second aspect of the present invention, the internal air may be blown out from the first air outlets (98a, etc.) in one of the directions forward and rearward of the vehicle; and wherein the external air may be blown out from the second air outlets (99a, etc.) in the remaining one of the directions forward and rearward of the vehicle.

According to a twenty-third aspect of the present invention, the internal air may be blown out from the first air outlets (98a, etc.) in one of the directions leftward and rightward of the vehicle, and the external air may be blown out from the second air outlets (99a, etc.) in the remaining one of the directions leftward and rightward of the vehicle.

According to a twenty-fourth aspect of the present invention, air-conditioning units (73, 74, 130) may include the internal air blowing means (75), the external air blowing means (80), the internal air paths (76, 135), the external air paths (81, 136) and the heat exchangers (78, etc.) may be arranged on the roof (71) of the vehicle cabin (10).

Incidentally, the reference numerals in parentheses, to denote the above means, are intended to show the relationship of the specific means which will be described later in an embodiment of the invention.

The present invention may be more fully understood from the description of preferred embodiments of the invention set forth below, together with the accompanying drawings.

### BRIEF DESCRIPTION OF THE DRAWINGS

FIG. 1 is a top plan view of the tractor cabin according to a first embodiment of the invention.

FIG. 2 is a side view of the tractor cabin shown in FIG. 1.

FIG. 3A is a cross sectional view of an air-conditioning unit shown in FIGS. 1 and 2, and FIG. 3B a longitudinal sectional view of the air-conditioning unit shown in FIGS. 1 and 2.

FIG. 4 is a cross sectional view of the air-conditioning unit according to a second embodiment of the invention.

FIG. 5 is a cross sectional view of the air-conditioning unit according to a third embodiment of the invention.

FIG. 6 is a cross sectional view of the air-conditioning unit according to a fourth embodiment of the invention.

FIG. 7 is a cross sectional view of the air-conditioning unit according to a fifth embodiment of the invention.

FIG. 8 is a cross sectional view of the air-conditioning unit according to a sixth embodiment of the invention.

FIG. 9 is a front sectional view as taken from the front portion of FIG. 8.

FIG. 10 is a side sectional view as taken transversely in FIG. 8.

FIG. 11 is a plan sectional view of the air-conditioning unit according to the sixth embodiment.

FIG. 12 is a sectional view taken in line A-A in FIG. 11.

FIG. 13 is a sectional view taken in line B-B in FIG. 11.

FIG. 14 is a block diagram showing the electric control according to the sixth embodiment.

FIG. 15 is a perspective view of an air-conditioning unit box according to a seventh embodiment of the invention.

FIG. 16 is a perspective view of an air-conditioning unit box according to an eighth embodiment of the invention.

FIG. 17 is a perspective view schematically showing the upper portion of the tractor cabin according to a ninth embodiment.

FIG. 18 is a front sectional view of the upper portion of the tractor cabin as taken from the front portion according to a tenth embodiment.

FIG. 19 is a side sectional view of the upper portion of the tractor cabin taken transversely according to the tenth embodiment.

FIG. 20 is a perspective view schematically showing the upper portion of the tractor cabin according to an eleventh embodiment.

FIG. 21 is a front sectional view of the upper portion of the tractor cabin as taken from the front portion according to the eleventh embodiment.

FIG. 22 is a side sectional view of the upper portion of the tractor cabin, as taken transversely, according to the eleventh embodiment.

FIG. 23 is a plan sectional view of the air-conditioning unit according to the eleventh embodiment of the invention.

FIG. 24 is a partly cutaway front view of the air-conditioning unit according to the eleventh embodiment of the invention.

FIG. 25 is a plan view schematically showing the tractor roof with the air-conditioning unit arranged according to a modification of the eleventh embodiment.

### DESCRIPTION OF PREFERRED EMBODIMENTS

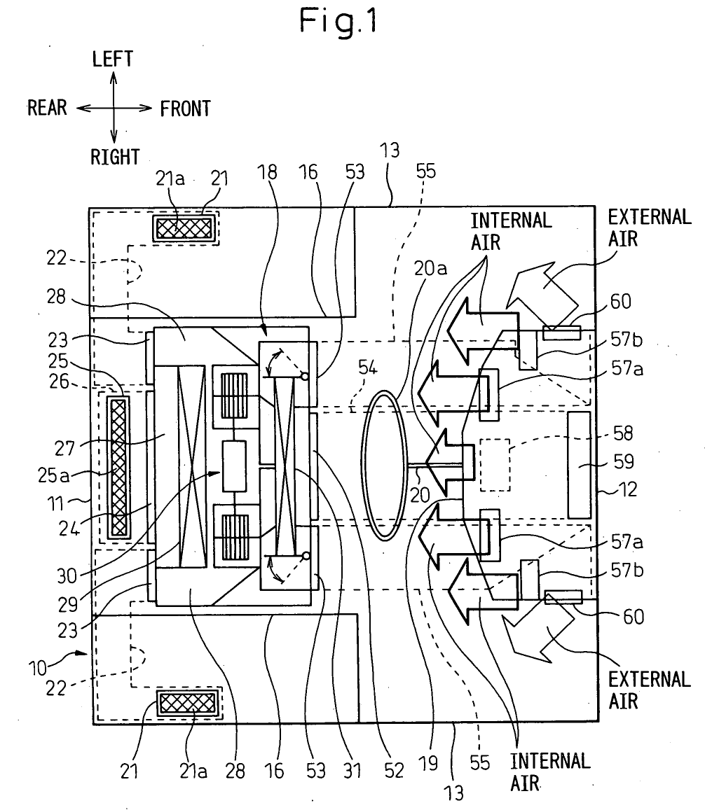

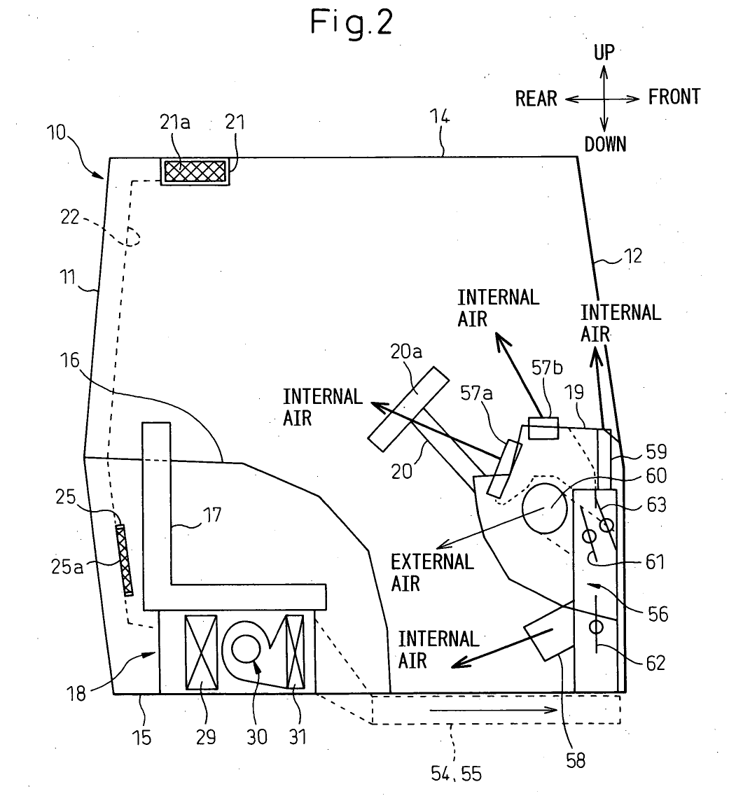

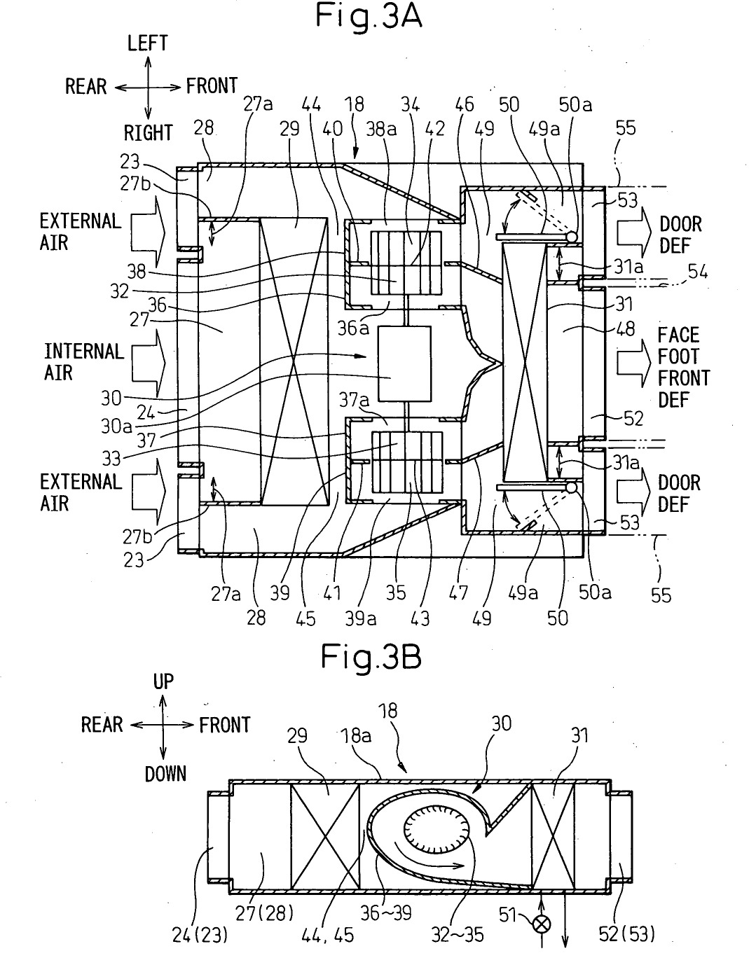

To begin with, a first embodiment is explained. FIGS. 1 to 3B show the first embodiment of the invention. A vehicle air conditioner according to this embodiment is used for an agricultural tractor. FIG. 1 is a top plan view of the cabin of the agricultural tractor, and FIG. 2 a side view of the cabin of the agricultural tractor. FIG. 3A is a cross sectional view of the air-conditioning unit according to the same embodiment, and FIG. 3B a longitudinal sectional view thereof. The arrows in longitudinal, vertical and horizontal directions attached in FIGS. 1 to 3B designate the front and rear, up and down, and left and right sides, respectively, of the agricultural tractor.

The cabin 10 of the agricultural tractor includes a rear window glass 11, a front wind shield 12, left and right door window glass 13, a ceiling 14 and a floor 15, which define the internal space of the cabin.

Tire fenders 16 are arranged in the lower rear portion on the left and right sides of the cabin 10. In the internal space of the cabin 10, a seat 7 for the tractor driver is arranged in the intermediate portion between the left and right tire fenders 16.

An air-conditioning unit 18 is mounted under the seat 17, i.e. between the lower surface of the seat 17 and the vehicle floor 15. Thus, the air-conditioning unit 18 is in the shape of a thin box with a small vertical size as shown in detail in FIG. 3.

In the internal space of the cabin 10, a meter cover (instrument board) 19 is arranged at the lower central portion on the front side. This meter cover 19 is equipped with meters including an engine tachometer and an engine water temperature meter and the operation switches, not shown, of the tractor.

A steering shaft 20 is obliquely arranged from the meter cover 19 rearward of the vehicle, and a steering wheel 20a is arranged at the upper end of the steering shaft 20.

The ceiling 14 of the cabin 10 is comparatively free of dust and has external air inlets 21 for introducing the external air (outdoor air). More specifically, the external air inlets 21 are arranged on the left and right sides of the ceiling 14 rearward of the vehicle. The left and right external air inlets 21 each have an external air filter 21a for trapping the dust in the external air. Also, the external air inlets 21 on the left and right sides are connected to the upper ends of the left and right external air ducts 22, respectively.

The external air ducts 22 are extended vertically along the body frame (not shown) arranged at the left and right corners in the rear portion of the cabin 10 (FIG. 2).

As shown in FIG. 3A, external air lead ports 23 are arranged on the left and right sides at the rear end of the air-conditioning unit 18. An internal air lead port 24 is arranged between the left and right external air lead ports 23 (at the transverse central portion of the vehicle). The lower ends of the left and right external ducts 22 are connected to the left and right external air lead ports 23, respectively, of the air-conditioning unit 18.

As shown in FIG. 3A, an internal air inlet 25 for introducing the internal air (air in the cabin) is arranged at the lower central portion in the rear portion of the internal space of the cabin 10. The internal air inlet 25 has an internal air filter 25a for trapping the dust, etc. in the internal air. The internal air inlet 25 also has a shutting mechanism, not shown, for opening and closing the internal air inlet 25. The shutting mechanism is manually operated by the passenger.

The internal air inlet 25 is connected to the upper end of the internal air duct 26, the lower end of which is connected to the internal air lead port 24 of the air-conditioning unit 18.

Next, a specific configuration of the air-conditioning unit 18 is explained. The air-conditioning unit 18 has a thin box-like case 18a as described above, in which an air path is formed for supplying air forward of the vehicle.

An internal air path 27 communicating with the internal air lead port 24 is formed at the transverse central portion in the case 18a. External air paths 28 communicating with the left and right external air lead ports 23 are formed on the left and right sides in the case 18a.

Inside the case 18a, therefore, the internal air path 27 and the external air paths 28 are basically formed in parallel to each other. According to this embodiment, however, the partitioning walls 27b between the internal air path 27 and the external air paths 28 are arranged transversely outward of the vehicle a predetermined amount more than the width of the internal air path 27, and therefore external air communication portions 27a communicating with the external air lead ports 23 are arranged on the left and right sides of the internal air path 27.

A cooling heat exchanger 29 having the same size as the area of the internal air path 27 is arranged on the internal air path 27. The entire amount of the air (internal air/external air) flowing into the internal air path 27 is passed through the cooling heat exchanger 29. The external air paths 28, on the other hand, are formed in parallel to the cooling heat exchanger 29 on the left and right outer sides of the cooling heat exchanger 29. Thus, the external air paths make up bypasses for the cooling heat exchanger 29.

The cooling heat exchanger 29 is an evaporator in the refrigeration cycle and, as is well known, includes a heat exchange core having tubes through which the refrigerant passes and fins coupled to the outer surface of the tubes. The air in the internal air path 27 passes through the gap of the heat exchange core, and the low-temperature low-pressure refrigerant in the refrigeration cycle absorbs heat from the passed air and is evaporated thereby to cool the air.

A compressor (not shown) for circulating the refrigerant in the refrigeration cycle is driven by a driving engine of the tractor through an electromagnetic clutch.

Inside the case 18a, a blower 30 is arranged downstream of the cooling heat exchanger 29 in the air flow. Further, a heating heat exchanger 31 is arranged downstream of the blower 30 in the air flow. Inside the case 18a, therefore, as viewed from the rear toward the front portions of the vehicle, the cooling heat exchanger 29, the blower 30 and the heating heat exchanger 31 are arranged in that order.

The blower 30 is configured as a biaxial fan motor including a drive motor 30a and blow fans 32 to 35 arranged on the axial sides of the drive motor 30a. In addition, internal air fans 32, 33 are arranged on the two axial sides of the drive motor 30a somewhat near to the center, and external air fans 34, 35 are arranged somewhat outward. The drive motor 30a, therefore, rotationally drives a total of four fans 32 to 35 integrally with each other.

The four fans 32 to 35 are each a centrifugal fan (a sirocco fan) in which blades having an arcuate cross section are arranged in a ring. The four fans 32 to 35 are accommodated in spiral scroll casings 36 to 39, respectively.

In order to partition the air paths of the air (internal air and external air) blown by the fans 32 to 35 from each other, partitioning plates 40, 41 are arranged between the scroll casings 36 and 38 on one axial side and between the scroll casings 37 and 39 on the other axial side, respectively. Further, partitioning plates 42, 43 are arranged between the internal air fan 32 and the external air fan 34 on one axial side and between the internal air fan 32 and the external air fan 35 on the other axial side, respectively.

The partitioning plates 40, 42 are arranged at the same position on one axial side of the blower 30, while the partitioning plates 41, 43 are arranged at the same position on the other axial side of the blower 30.

Air inlets 36a to 39a are formed on the axial side surfaces of the four scroll casings 36 to 39, respectively, and the internal air of the internal air path 27 or the external air of the external air path 28 is introduced into the scroll casings 36 to 39 from the air inlets 36a to 39a.

Communication paths 44, 45 are formed at predetermined intervals between the scroll casings 36, 38 on one axial side of the cooling heat exchanger 29 on the one hand and at predetermined intervals between the scroll casings 37, 39 on the other axial side of the cooling heat exchanger 29 on the other hand, so that the internal air path 27 and the external air paths 28 communicate with each other immediately after the cooling heat exchanger 29.

Inside the case 18a, downstream of the blower 30 in the air flow, there are arranged a partitioning plate 46 extending along the direction of extension (longitudinal direction of the vehicle) of the partitioning plates 40, 42 on one axial side, and a partitioning plate 47 extending along the direction of extension (longitudinal direction of the vehicle). of the partitioning plates 41, 43 on the other axial side. As a result, also downstream of the blower 30 in the air flow, the internal air path 48 is formed at the transversely central portion in the case 18a and the external air paths 49 are formed on the left and right sides in the case 18a.

The heating heat exchanger 31 is arranged over the entire area of the internal air path 48 and projected from the portion in the left and right external air paths 49 near to the central portion thereof. Numeral 31a designates the projections of the heating heat exchanger 31 into the external air paths 49.

Heater bypasses 49a are formed at the portion somewhat outward in the external air paths 49, and adapted to be opened or closed by heater bypass doors 50. The heater bypass doors 50 are each formed of a tabular door rotatable around the rotary axis 50a.

The heating heat exchanger 31 is a warm water heat exchanger for heating the air with the warm water (cool water) of the driving engine of the tractor as a heat source and, as is well known, includes a heat exchange core having tubes through which the warm water passes and fins coupled to the outer surface of the tubes. The air of the internal air path 48 and the external air paths 49 is heated as it passes through the gap of the heat exchange core.

The warm water valve 51 and the heat bypass doors 50 on the left and right sides are coupled and operatively interlocked with each other by a mechanical interlocking mechanism such as a cable or a link mechanism.

Specifically, when the warm water valve 51 is fully open, the heater bypass doors 50 are turned to the closed-up position (dashed line) of the heater bypasses 49a, while with the decrease in the opening degree of the warm water valve 51 from the full open position, the heater bypass doors 50 are turned to open the heater bypasses 49a thereby to increase the opening degree of the heater bypasses 49a. With the arrival of the warm water valve 51 at the closed-up position, the heater bypass doors 50 are turned to the full-open position (solid line) of the heater bypasses 49a.

The warm water valve 51 and the left and right heater bypass doors 50 are coupled to a temperature regulating operation member of an air-conditioning operation panel (not shown) through the mechanical interlocking mechanism described above. By manual operation of the temperature regulating operation member, therefore, the warm water valve 51 and the left and right heater bypass doors 50 are operated in collaboration with each other. The air-conditioning operation panel is arranged on or in the neighborhood of the meter cover 19.

An internal air outlet opening 52 communicating with the internal air path 48 downstream of the heating heat exchanger 31 is arranged at the transversely central portion of the case 18a nearest to the forward end of the vehicle. On the other hand, external air outlet openings 53 communicating with the external air paths 49 are arranged on the left and right sides of the case 18a nearest to the forward end of the vehicle.

Internal air outlet ducts 54 are connected to the internal air outlet opening 52 at the central portion, and external air outlet ducts 55 to the left and right external air outlet openings 53. These outlet ducts 54, 55 are arranged toward the vehicle front under the vehicle floor 15 (under floor) as shown in FIG. 2, while the front ends of the internal air outlet ducts 54 are connected to an outlet switch box 56 arranged in an area from the interior to the lower portion of the meter cover 19 in the internal space of the cabin 10.

The internal space of the outlet switch box 56 communicates with the face air outlets 57a, 57b, the foot air outlet 58 and the wind shield defroster air outlet 59. The external air outlet ducts 55, on the other hand, are connected directly to the door defroster air outlets 60 without the intermediary of the outlet switch box 56.

The internal space of the air outlet switch box 56 includes therein a face door 61 for opening/closing the communication path to the face air outlets 57a, 57b, a foot door 62 for opening/closing the communication path to the foot air outlet 58, and a defroster door 63 for opening/closing the communication path to the wind shield defroster air outlet 59.

These air outlet switching doors 61 to 63 are all rotatable tabular doors connected to the air outlet switching operation member arranged on the air-conditioning operation panel, so that the air outlets 57a, 57b, 58, 59 can be opened or closed by manually operating the operation member.

The face air outlets 57a, 57b are for blowing the air-conditioned air to the face of the driver seated in the seat 17, and arranged above the meter cover 19 as shown in FIG. 2. The foot air outlet 58 is for blowing the air-conditioned air to the feet of the driver and arranged at one point under the central portion of the meter cover 19.

The wind shield defroster air outlet 59 is for blowing the air-conditioned air toward the wind shield 12 of the cabin 10 and defogging the wind shield 12, and arranged at the foremost position on the upper surface of the meter cover 19. (lower end of the wind shield 12).

From the door defroster air outlets 60, on the other hand, the external air-conditioned air are blown in the directions other than toward the body of the driver seated in the seat 17, or specifically, toward the left and right door window glass 13 of the cabin 10 to increase the internal pressure of the cabin 10. During the heating operation in winter, the external warm air is blown out toward the door window glass 13 from the door defroster air outlets 60 thereby to defog the door window glass 13.

In addition to the temperature regulation operating member and the air outlet switching operation member described above, an air amount changing operation switch of the blower 30, a compressor operation switch of the refrigeration cycle, etc. are arranged on the air-conditioning operation panel not shown.

Next, the operation of this embodiment is explained. During the cooling operation in summer, the temperature regulating operation member of the air-conditioning operation panel is set to the lowest temperature position (maximum cooling position). As a result, the warm water valve 51 is closed up, and in collaboration with this, the heater bypass doors 50 are set to the full-open position (solid line) of the heater bypasses 49a.

With the turning on of the compressor operation switch of the air-conditioning operation panel, the electromagnetic clutch of the compressor in the refrigeration cycle is energized and connected, and the compressor is driven by the engine. As a result, in the cooling heat exchanger (evaporator) 29, the low-temperature low-pressure refrigerant in the refrigeration cycle absorbs heat from the air and evaporates thereby to cool the air.

With the turning on of the air amount change operation switch of the air-conditioning operation panel, on the other hand, the drive motor 30a of the blower 30 is started, and the blow fans 32 to 35 are integrally rotated thereby to start the blowing operation. In the process, the passenger opens the internal air outlet 25 by manually operating the shutting mechanism (not shown), so that the internal air outlet 25 communicates with the internal space of the cabin 10.

As a result, due to the sucking force of the internal air fans 32, 33 of the blow fans 32 to 35, the internal air (in the cabin) is passed through the internal air outlet 25, the internal air duct 26, the internal air lead port 24 of the air conditioning unit 18, the internal air path 27 and the cooling heat exchanger 29 in that order, so that the internal air is cooled into a cool air by the cooling heat exchanger 29.

This cool air is sucked into the air inlets 36a, 37a of the internal air scroll casings 36, 37, and further reaches the air outlet switch box 56 by flowing through the heating heat exchanger 31, the internal air path 48, the internal air outlet opening 52 and the internal air outlet ducts 54 in that order. In the process, no warm water flows through the heating heat exchanger 31, which therefore works only as an air path without heating the air.

During the cooling operation in summer, on the other hand, the communication path to the face air outlets 57a, 57b is normally opened by the face door 61 in the air outlet switch box 56, and therefore, the cool air in the air outlet switch box 56 is blown toward the face of the driver in the seat 17 from the face air outlet 57a, 57b thereby to cool the body or the-neighborhood of the driver.

The external air (air outside the cabin) is sucked into the external air ducts 22 from the external air inlets 21 of the cabin ceiling 14 by the operation of the external air fans 34, 35 of the blower 30. Further, this external air is sucked into the air inlets 38a, 39a of the external air scroll casings 38, 39 through the external air ducts 22, the external air lead ports 23 of the air-conditioning unit 18 and the external air paths 28 in that order. This external air flow bypasses the cooling heat exchanger 29 and therefore is not cooled.

This external air flow passes through the heater bypasses 49a of the external air paths 49 downstream of the external air fans 34, 35 and the left and right projections 31a of the heating heat exchanger 31 projected into the external air paths 49, and reaches the door defroster air outlets 60 through the external air outlet openings 53 and the external air outlet ducts 55.

The external air is blown out toward the left and right door window glass 13 of the cabin 10 from the door defroster air outlets 60. The tractor cabin 10, unlike that of the ordinary passenger car, has no air discharge port for discharging the air out of the cabin. By introducing the external air into the cabin 10, therefore, the internal pressure of the cabin 10 is increased. As a result, the intrusion of dust, etc. into the cabin 1 is prevented.

Further, by blowing out the external air from the door defroster air outlets 60 toward the left and right door window glass 13 of the cabin 10, the external air thus blown out does not proceed toward the body of the driver in the seat 17. Even in the case where the external air blown out is high in temperature, the driver feels no discomfort due to the cooling operation.

Incidentally, the provision of the external air communication portions 27a communicating with the external air lead ports 23 on both left and right sides of the internal air path 27 causes a part of the external air passing through the external air lead ports 23 to flow into the external air communication portions 27a of the internal air path 27, and the external air of the external air communication portions 27a is cooled into a cool air as it passes through the left and right sides of the heat exchange core of the cooling heat exchanger 29. This cool air is sucked into the external air inlets 38a, 39a or the internal air inlets 36a, 37a from the communication paths 44, 45 immediately after the cooling heat exchanger 29.

Only a small amount of the external air flows through the external communication portions 27a of the internal air path 27, and the main stream of the external air bypasses the cooling heat exchanger 29. Basically, therefore, the cooling heat exchanger 29 recirculates and cools the low-temperature internal air.

As compared with the conventional case in which the mixed air of the external air high in humidity and the internal air is cooled by the cooling heat exchanger, therefore, the heat load of the cooling heat exchanger 29 is reduced. Therefore, the air cooling temperature of the cooling heat exchanger 29 can be reduced for an improved cooling performance. At the same time, the power consumption of the compressor is also reduced due to the decreased cooling heat load.

In the case where the temperature of the air blown into the cabin is regulated during the cooling operation, the temperature regulating operation member on the air-conditioning operation panel is turned from the lowest-temperature position (maximum cooling position) to the temperature-rising side. Then, the warm water valve 51 opens from the closed-up state and the warm water circulates through the heating heat exchanger 31. At the same time, the flow rate of the warm water to the heating heat exchanger 31 can be adjusted by adjusting the opening degree of the warm water valve 51 in accordance with the operation amount of the temperature regulating operation member. By thus adjusting the flow rate of the warm water, the heat radiation amount of the heating heat exchanger 31 can be adjusted and so is the temperature of the air blown into the cabin.

Upon manual operation of the shutting mechanism (not shown) of the internal air inlet 25 by the passenger to a closed-up state, the communication is cut off between the internal air inlet 25 and the internal space (cabin interior) of the cabin 10, and therefore the internal air is not sucked in, and the air-conditioning unit 18 can be set to the total external air sucking mode.

The external air communication units 27a located on both left and right sides of the internal path 27 are formed to set the total external air sucking mode. The external air reaching the external air lead ports 23 of the air-conditioning unit 18 through the external air ducts 22 from the external air inlets 21 of the cabin ceiling 14 is divided into two streams, one sucked into the external air inlets 38a, 39a of the blower 30 from the external air paths 28, and the other flowing through the cooling heat exchanger 29 from the external air communication units 27a of the internal air path 27 and sucked into the internal air inlets 36a, 37a of the blower 30.

Even in the case where the air-conditioning unit 18 is set to the total external air sucking mode, therefore, the external cool air cooled by the cooling heat exchanger 29 can be blown out in the neighborhood of the driver to exhibit the cooling effect.

During the cooling operation, the communication path to the face air outlets 57a, 57b is opened by the face door 61, and the communication path to the foot air outlet 58 is opened by the foot door 62. Then, the cool air in the outlet switch box 56 can be blown out to the face of the driver in the seat 17 from the face air outlets 57a, 57b, while at the same time blowing out the air from the foot air outlet 58 to the feet of the driver. When the atmospheric temperature is very high, therefore, the feeling of the cooling operation, over the whole body of the driver, can be rapidly increased.

Next, the heating operation in winter is explained. The temperature regulating operation member of the air-conditioning operation panel is set to the maximum temperature position (maximum heating position). As a result, the warm water valve 51 is set to full open position, and in operatively interlocked relation to this, the heater bypass doors 50 are set to the closed-up position (dashed line) of the heater bypasses 49a.

During the heating operation, the cooling operation of the cooling heat exchanger 29 is normally unrequired, and therefore the compressor operation switch of the air-conditioning operation panel is not turned on, and the compressor in the refrigeration cycle is stopped. On the other hand, the air amount change operation switch of the air-conditioning operation panel is turned on so that the drive motor 30a of the blower 30 is started and the blow fans 32 to 35 are integrally rotated. Also, the shutting mechanism (not shown) of the internal air inlet 25 is opened so that the internal air inlet 25 communicates with the internal space (cabin interior) of the cabin 10.

As a result, the internal air in the internal air lead port 24 of the air-conditioning unit 18 is blown to and heated by the heating heat exchanger 31 by the internal air fans 32, 33 into a warm air. Also, the external air in the external air lead ports 23 of the air-conditioning unit 18 is blown to the external air path 49 by the external air fans 34, 35. In the process, the heater bypasses 49a are closed up by the heater bypass doors 50, and therefore all the external air in the external air paths 49 is heated, by the left and right projections 31a of the heating heat exchanger 31, to warm air.

Further, the warm water flow rate to the heating heat exchanger 31 is maximized by the full open state of the warm water valve 51, and therefore the heat radiation amount of the heating heat exchanger 31 is maximized, thereby making it possible to heat the internal air and the external air to a maximum degree. The heat exchange area of the projections 31a located in the external air paths 49 of the heating heat exchanger 31 is greatly reduced as compared with the heat exchange area of the portion located in the internal air path 48. Also, as the external air suck-in temperature is lower than the internal air suck-in temperature, the temperature of the warm external air is much lower than the temperature of the warm internal air.

The warm internal air flows from the internal air outlet opening 52 through the internal air outlet duct 54 and reaches the air outlet switch box 56. During the heating operation in winter, the communication path to the foot air outlet 58 is normally opened by the foot door 62 in the air outlet switch box 56. Thus, the warm air in the air outlet switch box 56 is blown out to the feet of the driver in the seat 17 from the foot air outlet 58 thereby heating the neighborhood of the feet of the driver.

In the process, substantially the entire portion of the heating heat exchanger 31 located in the internal air path 48 heats only the internal air and produces a warm internal air. Unlike in the conventional case where the external and internal airs are mixed and heated by the heating heat exchanger, therefore, the heat load on the heating heat exchanger 31 is reduced, and the temperature (warm air temperature) of the air blown out of the heating heat exchanger 31 can be increased. Thus, the driver's feeling of the heating operation is improved.

The warm external air, on the other hand, reaches the door defroster air outlets 60 through the external air outlet openings 53 and the external air outlet ducts 55, and is blown out toward the left and right door window glass 13 of the cabin 10 from the door defroster air outlets 60. As a result, the internal pressure of the cabin 10 is increased and the intrusion of dust or the like into the cabin 10 is suppressed.

Also, the warm external air which is considerably lower in temperature than the warm internal air is not blown directly to the body of the driver and, therefore the driver's feeling of the heating operation is not adversely affected. Further, the warm external air thus blown out works effectively to defog the door window glass 13.

In the case where the communication path to the face air outlets 57a, 57b is opened by the face door 61 in the air outlet switch box 56 during the heating operation, the warm air in the air outlet switch box 56 is blown out to the feet of the driver from the foot air outlet 58 and also to the face of the driver from the face air outlets 57a, 57b. As a result, the driver's feeling of the heating operation is rapidly improved.

Also during the heating operation, if the temperature regulating operation member of the air-conditioning operation panel is set from the maximum temperature position (maximum heating position) down to a lower temperature, the opening degree of the warm water valve 51 is reduced and therefore the amount of warm water flowing to the heating heat exchanger 31 is reduced. In this way, the temperature of the air (warm air temperature) blown into the cabin can be adjusted.

Further, in the case where the compressor in the refrigeration cycle is activated by turning on the compressor operation switch on the air-conditioning operation panel during the heating operation, the cooling operation is performed by the cooling heat exchanger 29, and therefore the dehumidification heating operation can be performed.

Next, the defrost mode for defogging the vehicle window glass is explained. A communication path to the wind shield defroster air outlet 59 is opened by the defroster door 63 in the air outlet switch box 56. The vehicle window glass are often defogged during the winter season when the window glass temperature drops. The temperature regulating operation member of the air-conditioning operation panel, therefore, is set to the maximum temperature position (maximum heating position) or the vicinity thereof.

As a result, the warm water valve 51 is set to the full open position or the vicinity thereof. Also, the heater bypass doors 50 are turned to the closed-up position (dashed line) of the heater bypasses 49a or the vicinity thereof.

The shutting mechanism (not shown) of the internal air inlet 25 is opened, so that the internal air inlet 25 communicates with the internal space (cabin interior) of the cabin 10. Then, the air amount change operation switch on the air-conditioning operation panel is turned on to start the drive motor 30a of the blower 30, so that the blow fans 32 to 35 are rotated.

Thus, the internal air is heated by the portion of the heating heat exchanger 31 located in the internal air path 48 into a warm air, and blown out toward the wind shield 12 of the cabin 10 from the wind shield defroster air outlet 59. At the same time, the external air is heated into a warm air by the projections 31a on both sides of the heating heat exchanger 31 in the external air paths 49, and blown out toward the left and right door window glass 13 of the cabin 10 from the door defroster air outlets 60.

In the process, the warm internal air is higher in absolute temperature than the warm external air. Nevertheless, the temperature of the warm internal air can be considerably increased as compared with the warm external air, and therefore the relative humidity of the warm internal air can be reduced.

Further, the agricultural tractor runs at a very low speed as compared with ordinary passenger cars, and therefore the window glasses 12, 13 are not cooled by the low-temperature wind which otherwise might caused by the running vehicle. In other words, under the same atmospheric temperature conditions, the window glass temperature of the agricultural tractor is higher than that of the passenger car. Further, the cabin of the agricultural tractor is always occupied by one person, and therefore less moisture is generated, than in the case of passenger cars, by the perspiration of the cabin passenger.

Under these multiplex conditions, the wind shield 12 of the cabin 10 can be defogged by increasing the temperature of the warm internal air.

Also, the door window glass 13 of the cabin 10, though low in temperature, can be defogged by the warm, low humidity external air blown out thereto. Naturally, in defrost mode, dust intrusion can be suppressed by increasing the internal pressure of the cabin by introducing the external air.

During both the heating operation and the defroster operation, the air-conditioning unit 18 can be set to the total external air suck-in mode by closing the shutting mechanism (not shown) of the internal air inlet 25, and therefore the heating function and the defroster function can be executed by totally sucking in the external air.

According to the first embodiment, the door defroster air outlets 60 are provided for blowing the external air toward the left and right door window glass 13 of the cabin 10. In place of the door defroster air outlets 60, however, at least a flow air outlet may be arranged to blow out the external air toward the floor surface of the cabin 10.

Specifically, the external air is blown from the floor air outlets to the portion of the floor surface of the cabin 10 distant from the driver's feet, such as the floor surface portions just under the door window glass 13. Then, the external air thus blown is prevented from directly contacting the driver and therefore the driver's feeling of the air-conditioning operation is not adversely affected. At the same time, the internal pressure of the cabin 10 is increased by the external air thus blown, and the dust intrusion into the cabin 10 can be suppressed.

According to this modification, the external air outlet ducts 55 may not be extended into the meter cover 19 located in the front portion of the cabin 10 but a short duct extending to the neighborhood of the seat 17 may be used. As a result, the forward ends of the external air outlet ducts 55 are located in the neighborhood of the seat 17 and therefore the external air can be blown to the floor surface portion in the neighborhood of the seat 17.

According to the first embodiment, the temperature regulating operation member of the air-conditioning operation panel is manually operated for collaborative operation between the warm water valve 51 and the left and right heater bypass doors 50. As an alternative, the warm water valve 51 and the left and right heater bypass doors 50 are coupled to the actuator mechanism including a servo motor through a link mechanism or the like, and by the driving force of the actuator mechanism, the warm water valve 51 and the left and right heater bypass doors 50 may be operated in collaboration with each other. In this case, the operation amount of the actuator mechanism is adjusted by the temperature regulating operation member of the air-conditioning operation panel.

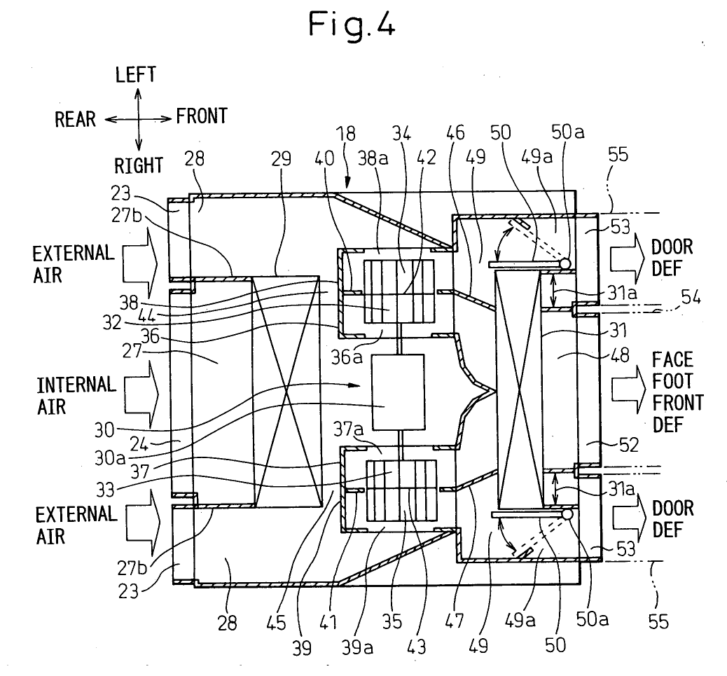

Next, a second embodiment is explained. According to the first embodiment, the external air communication portions 27a are arranged on the left and right sides of the internal air path 27, and part of the external air introduced from the external air communication portions 27a is cooled as it passes through the cooling heat exchanger 29. According to the second embodiment, in contrast, as shown in FIG. 4, the external air communication portions 27a are eliminated, and the whole area of the cooling heat exchanger 29 is arranged only in the internal air path 27.

As a result, the cooling heat exchanger 29 cools only the internal air, and therefore the heat load of the cooling heat exchanger 29 can be further reduced. Thus, the power consumption of the compressor is further reduced.

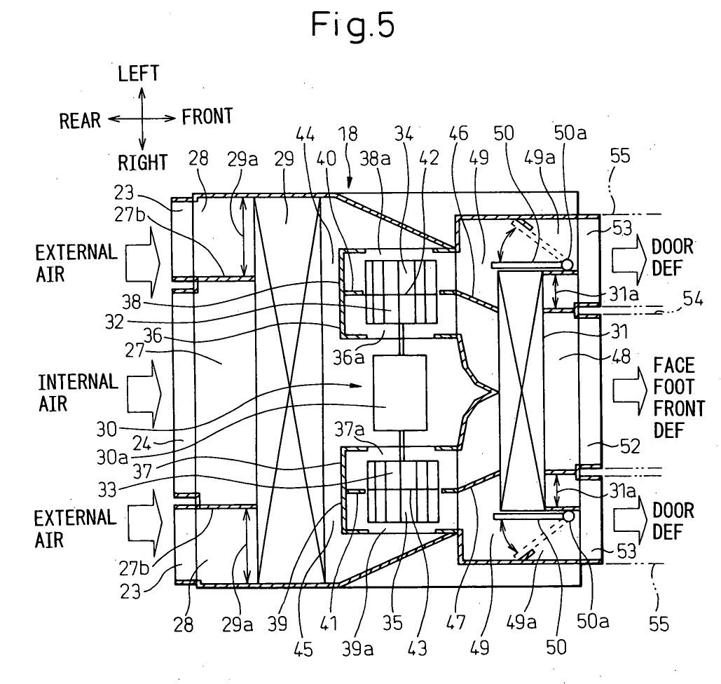

Next, a third embodiment of the invention is explained. According to the first embodiment, the external air paths 28 are arranged in parallel to the cooling heat exchanger 29, which is bypassed by the external air passing through the external air paths 28. According to the third embodiment, in contrast, projections 29a are formed on the cooling heat exchanger 29 over the whole area of the external air paths 28 as shown in FIG. 5, so that the total amount of the external air of the external air paths 28 can be cooled by the cooling heat exchanger 29.

As a result, although the heat load of the cooling heat exchanger 29 is increased during the cooling operation, the temperature of the air blown from the door defroster air outlets 60 can be reduced more than in the first embodiment, and therefore the room temperature of the whole cabin 10 can be reduced.

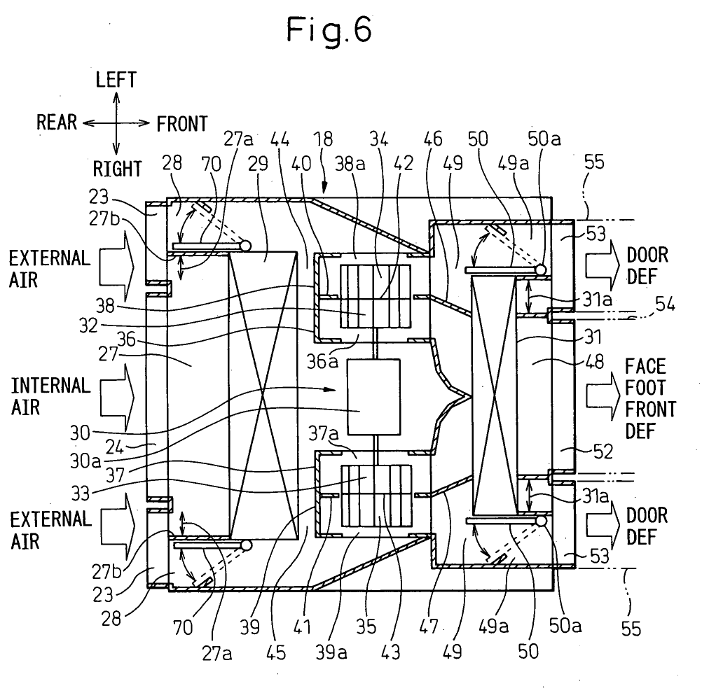

Next, a fourth embodiment is explained. According to the fourth embodiment, as shown in FIG. 6, external air shut doors 70 are additionally arranged in the external air paths 28. As a result, when the external air paths 28 are closed by the external air shut doors 70, the external air is introduced only through the external air communication portions 27a located on both sides of the internal air path 27 and, therefore, the external air is introduced in lesser amount than in the first embodiment.

As a result, the temperature of the air blown from the door defroster air outlets 60 can be decreased during the cooling operation and increased during the heating operation.

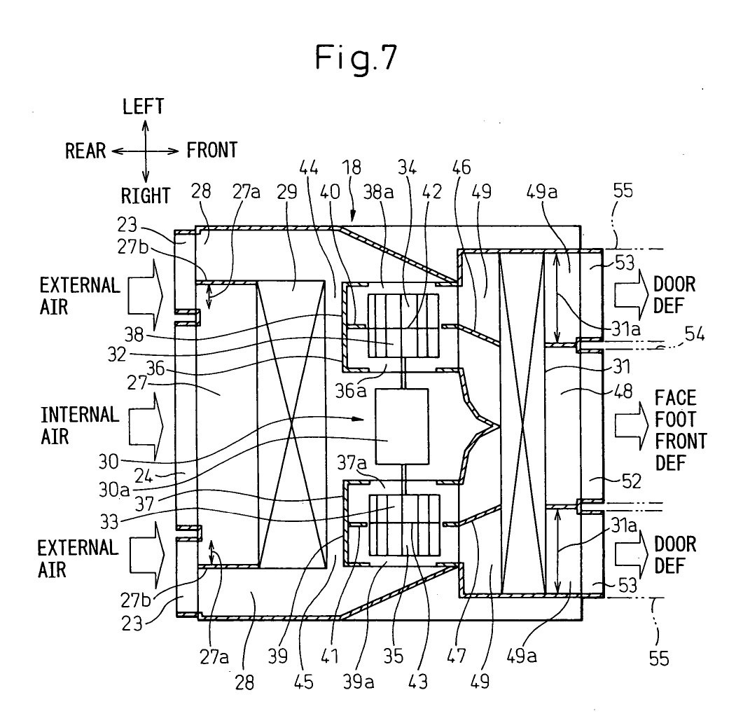

Next, a fifth embodiment is explained. According to the fifth embodiment, as shown in FIG. 7, projections 31a are formed on the heating heat exchanger 31 over the whole area of the external air paths 49 and the heater bypasses 49a are eliminated. As a result, the total amount of the external air in the external air paths 49 can be heated by the heating heat exchanger 31.

In this configuration, although the heat load of the heating heat exchanger 31 is increased during the heating operation, the temperature of the air blown from the door defroster air outlets 60 can be increased more than in the first embodiment, and therefore the room temperature of the whole cabin 10 can be increased.

Next, a sixth embodiment is explained. According to the first to fifth embodiments described above, the internal air path 27 and the external air paths 28 are arranged in parallel to each other in a single air-conditioning unit 18, and the internal air and the external air are supplied separately to the internal air path 27 and the external air paths 28, respectively, with a single blower 30. According to the sixth embodiment, on the other hand, completely separate air paths are formed as two air-conditioning units, i.e. an internal air-conditioning unit and an external air-conditioning unit are configured independent of each other.

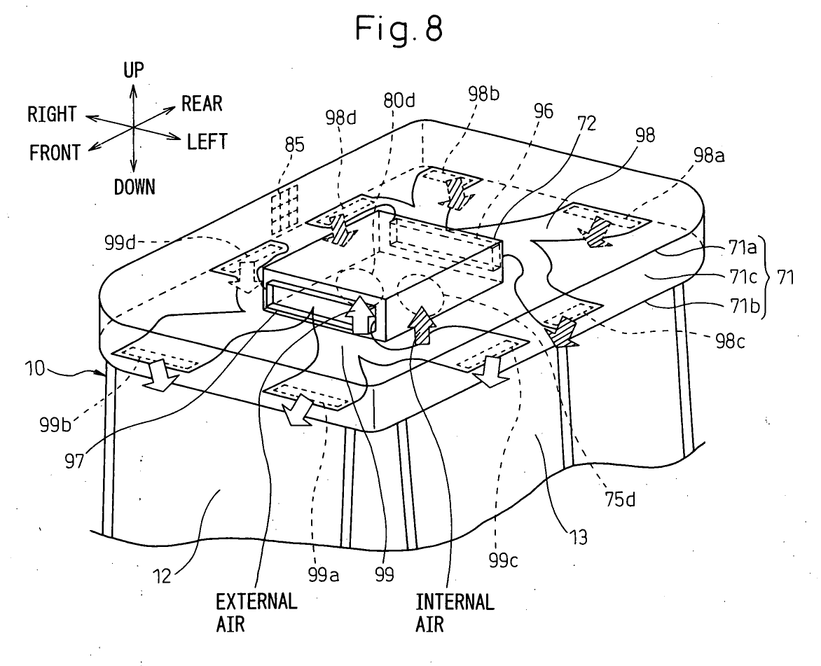

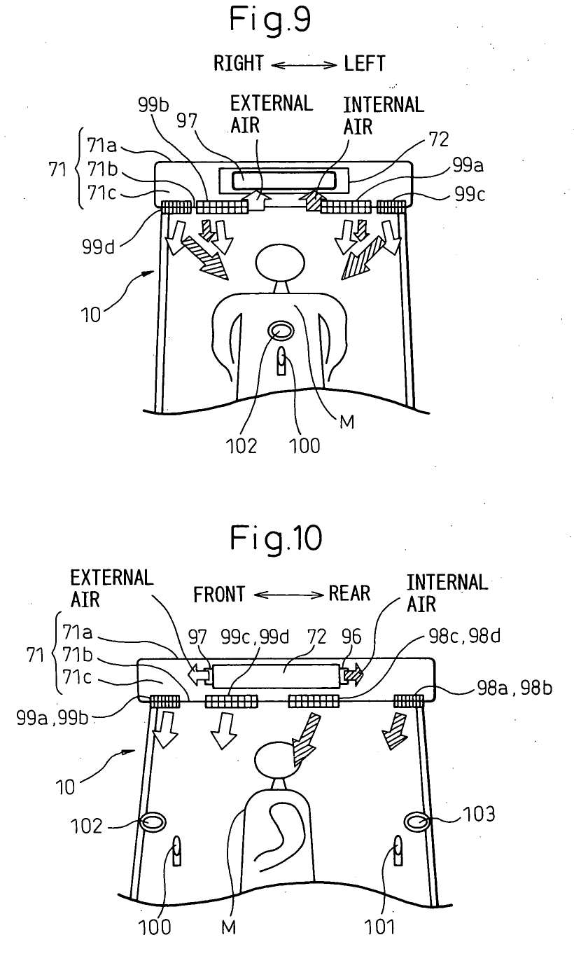

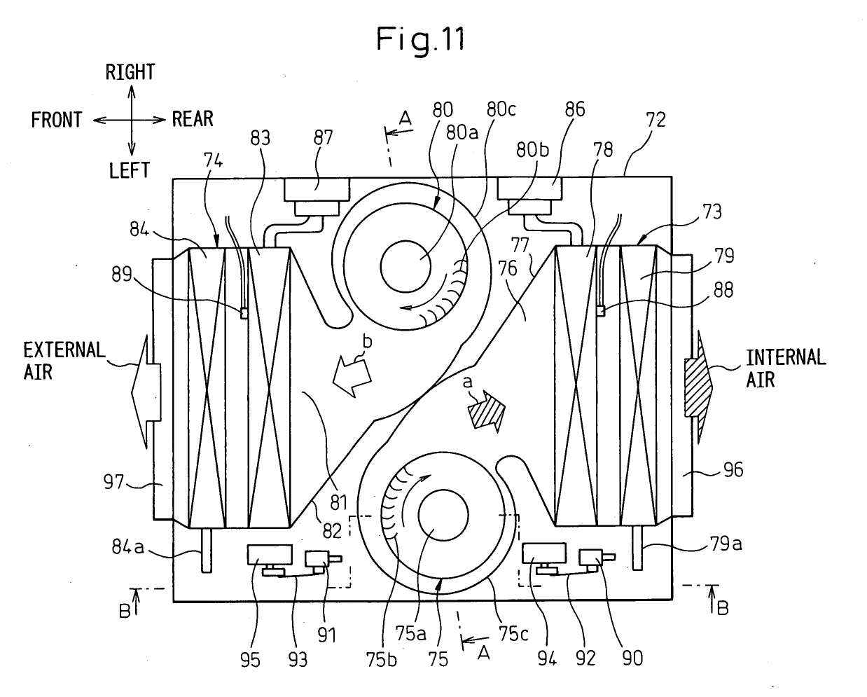

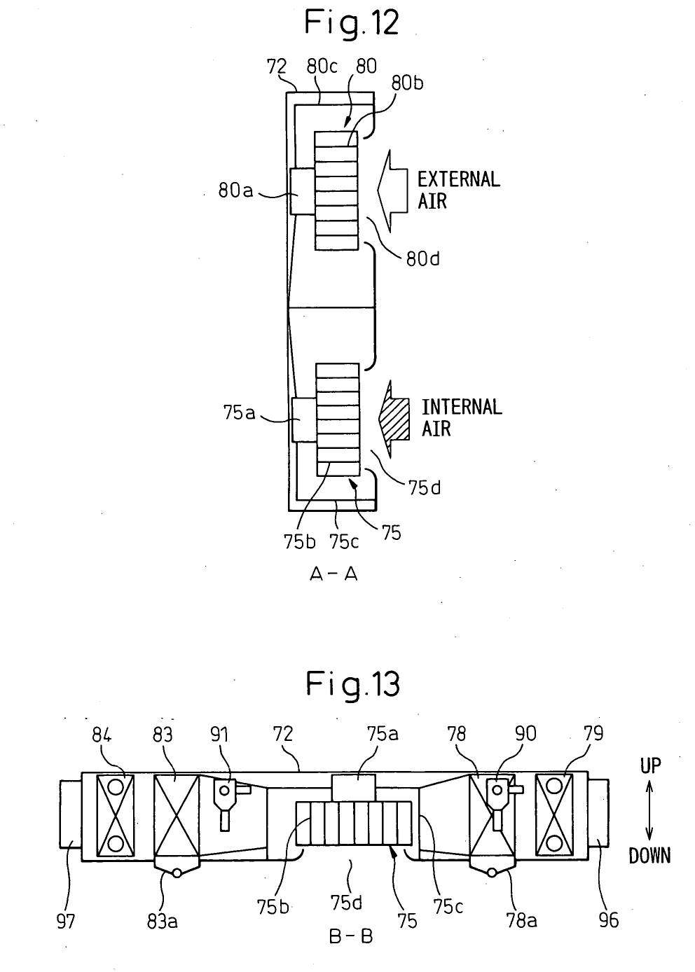

FIG. 8 is a perspective view schematically showing the upper portion of the vehicle cabin 10 according to the sixth embodiment. FIG. 9 is a front sectional view as taken from the front portion in FIG. 8. FIG. 10 is a side sectional view as taken from the transverse side of FIG. 8. FIG. 11 is a plan sectional view showing the air-conditioning unit. FIG. 12 is a sectional view taken in line A-A in FIG. 11. FIG. 13 is a sectional view taken in line B-B in FIG. 11.

In the vehicle cabin 10 according to the sixth embodiment, a space 71c of a predetermined size is formed between an upper plate 71a and a lower plate 71b of the roof 71 as shown in FIGS. 8 to 10. The lower plate 71b corresponds to the ceiling 14 of the vehicle cabin 10 according to the first embodiment.

A rectangular air-conditioning unit box 72 is arranged in the internal space 71c of the roof 71. In FIG. 8, the air-conditioning unit box 72 and the air outlet ducts 98, 99 are shown in perspective view.

The air-conditioning unit box 72 accommodates an internal air-conditioning unit 73 and an external air-conditioning unit 74 as shown in FIGS. 11 to 13. The units 73, 74 exhibit the air-conditioning function independently of each other.

The internal air-conditioning unit 73 includes, independently from each other, an internal air blower 75, a case 77 making up an internal air path 76, a cooling heat exchanger 78 and a heating heat exchanger 79. In similar fashion, the external air-conditioning unit 74 includes, independently from each other, an external air blower 80, a case 82 making up an external air path 81, a cooling heat exchanger 83 and a heating heat exchanger 84.

The internal air blower 75 and the external air blower 80 are both centrifugal blowers, and configured of drive motors 75a, 80a, centrifugal blow fans 75b, 80b rotationally driven by the motors 75a, 80a and spiral scroll cases 75c, 80c.

In this configuration, the drive motors 75a, 80a for the blowers 75, 80 are brushless motors integrated with a drive circuit for regulating the rotational speed according to this embodiment.

The internal air blower 75 and the external air blower 80 are formed symmetrically with each other in such a manner that the air is blown out from them in opposite directions. Specifically, the blowers 75, 80 are arranged symmetrically with each other in such a manner that the air from the scroll case 75c of the internal air blower 75 is blown substantially rearward of the vehicle along the arrow a, while the air from the scroll case 80c of the external air blower 80 is blown substantially forward of the vehicle along the direction of arrow b. As a result, the blowers 75, 80 can share parts.

In the scroll cases 75c, 80 of the blowers 75, 80, air inlets 75d, 80d are opened in the lower parts of the blow fans 75b, 80b. The air inlet 75d of the internal air blower 75 communicates with the interior of the cabin 10 and sucks in the internal air. The air inlet 80d of the external air blower 80, on the other hand, communicates with the external air port 85 (FIG. 8), through not shown external air ducts, and sucks in the external air.

In the configuration of this embodiment, the external air outlet 85 is arranged somewhat transversely rightward of the roof 71, and therefore the external air port 85 is arranged on the right side surface of the roof 71. The external air port 85 includes an external air filter (not shown) for trapping the dust and the like contained in the external air.

The cooling heat exchangers 78, 83, like the cooling heat exchanger 29 in the first embodiment, are configured of an evaporator in the refrigeration cycle. The low-pressure refrigerant that has passed through the expansion valves 86, 87 (FIG. 11) making up the pressure-reducing means of the refrigeration cycle flow in parallel through the cooling heat exchangers 78, 83.

The expansion valves 86, 87 are merged into one high-pressure pipe at the upstream side thereof in the refrigerant flow, and are connected to the downstream side of a condenser or a liquid receiver, not shown, in the refrigerant flow. Also, the cooling heat exchangers 78, 83 are merged at the downstream side thereof in the refrigerant flow into a low-pressure pipe and connected to the inlet side of the compressor.

The lower portion of the cooling heat exchangers 78, 83 includes drain pans 78a, 83a (FIG. 13) for collecting and discharging the condensed water. The cooling heat exchangers 78, 83 include temperature sensors 88, 89 (FIG. 1), respectively. These temperature sensors 88, 89 are specifically thermistors for detecting the fin surface temperature.

The heating heat exchangers 79, 84, on the other hand, like the heating heat exchanger 31 in the first embodiment, heat the air with warm water (engine cooling water) as a heat source. The two heating heat exchangers 79, 84 are connected in parallel by a warm water circuit. The inlet-side one of the warm water pipes 79a, 84a of the heating heat exchangers 79, 84 have independent warm water valves 90, 91 (FIG. 11, 13), respectively, corresponding to the warm water valve 51 in the first embodiment.

The warm water valves 90, 91 make up a heating capacity adjusting means having the function to open/close a warm water path to adjust the warm water path area and thus to adjust the warm water flow rate. As shown in FIG. 11, the warm water valves 90, 91 are coupled to actuator mechanisms 94, 95 such as servo motors through link mechanisms 92, 93, respectively. The two warm water valves 90, 91 can be operated independently of each other by the actuator mechanisms 94, 95.

In the internal air path 76 formed by the case 77 of the internal air-conditioning unit 73, the internal air flows rearward and, therefore, an internal air outlet opening 96 is formed at the rear end of the internal air path 76.

In the external air path 81 formed by the case 82 of the external air-conditioning unit 74, on the other hand, the external air flows forward and, therefore, an external air outlet opening 97 is formed at the forward end of the external air path 81.

An internal air outlet duct 98 is connected, as shown in FIG. 8, to the internal air outlet opening 96 of the internal air-conditioning unit 73. This internal air outlet duct 98 is branched into four parts including the left and right sides in the rear portion and the left and right transverse sides of the vehicle from the position of the internal air outlet opening 96. Internal air-conditioning air outlets 98a to 98d are arranged at the forward ends of the branch ducts.

The four internal air outlets 98a to 98d, as shown in FIG. 10, are arranged on the lower plate 81b of the roof constituting the cabin ceiling. As shown in FIG. 8, the internal air outlets 98a, 98b are arranged on the transversely left and right sides in the rear portion of the cabin ceiling, and the internal air outlets 98c, 98d on the transverse left and right sides at the longitudinally intermediate portion of the cabin ceiling.

The four internal air outlets 98a to 98d blow the internal air in the directions toward the passenger M along the diagonal arrows in FIGS. 8 to 10, i.e. toward the central portion of the cabin. The internal air outlets 98a to 98d are each equipped with a grill mechanism (not shown) to adjust the direction of air flow manually. The direction of air flow can thus be adjusted in such a manner that during the cooling operation, the cool internal air is blown out toward the upper half part of the passenger M while during the heating operation, the warm internal air is blown out toward the lower half part of the passenger M.

The external air outlet opening 97 of the external air-conditioning unit 74, on the other hand, is connected to an external air outlet duct 99 as shown in FIG. 8. This external air outlet duct 99 branches into four parts including the transversely left and right sides in the front portion and transversely left and right sides of the vehicle from the external air outlet opening 97, and external air-conditioned air outlets 99a to 99d are arranged at the forward ends of the branch ducts.

The four external air outlets 99a to 99d are arranged on the lower plate 71b of the roof constituting the cabin ceiling as shown in FIGS. 9, 10. The external air outlets 99a, 99b are arranged on the transversely left and right sides at the forward end of the cabin ceiling and the external air outlets 99c, 99d on the transversely left and right sides at the longitudinally intermediate portion of the cabin ceiling.

The four external air outlets 99a to 99d blow the external air-conditioned air toward parts other than the passenger. The two external air outlets 99a, 99b located in the front portion of the cabin blow the external air-conditioned air from the part above the wind shield 12 (FIG. 8) of the cabin downward along the inner surface of the wind shield 12.

The two external air outlets 99c, 99d located on the left and right sides of the cabin ceiling, on the other hand, are adapted to blow the external air-conditioned air from the part above the door window glass 13 (FIG. 8) on the left and right sides of the cabin downward along the inner surface of the door window glass.

As described above, the external air outlets 99a to 99d, which blow the external air-conditioned air toward parts other than the passenger and not directly to the body of the passenger M, have no grille mechanism capable of adjusting the direction of air flow.

In order to prevent the window glass from being cooled and fogged by the cool air blown from the external air outlets 99a to 99d during the cooling operation, the external air outlets 99a to 99d are so designed as to blow the external air-conditioned air downward from a point a predetermined distance away from the inner surface of the window glass.

As understood from the foregoing description, the internal air-conditioned air from the internal air-conditioning unit 73 is blown mainly to the rear area in the internal space of the cabin 10, and the external air-conditioned air from the external air-conditioning unit 74 mainly to the front area in the internal space of the cabin 10.

In order to control the air-conditioning operation in the rear area and the air-conditioning operation in the front area in the cabin space independently of each other, internal air sensors 100, 101 and sunlight sensors 102, 103 are arranged independently of each other in the rear and front areas, respectively, in the internal space of the cabin, as shown in FIG. 10.

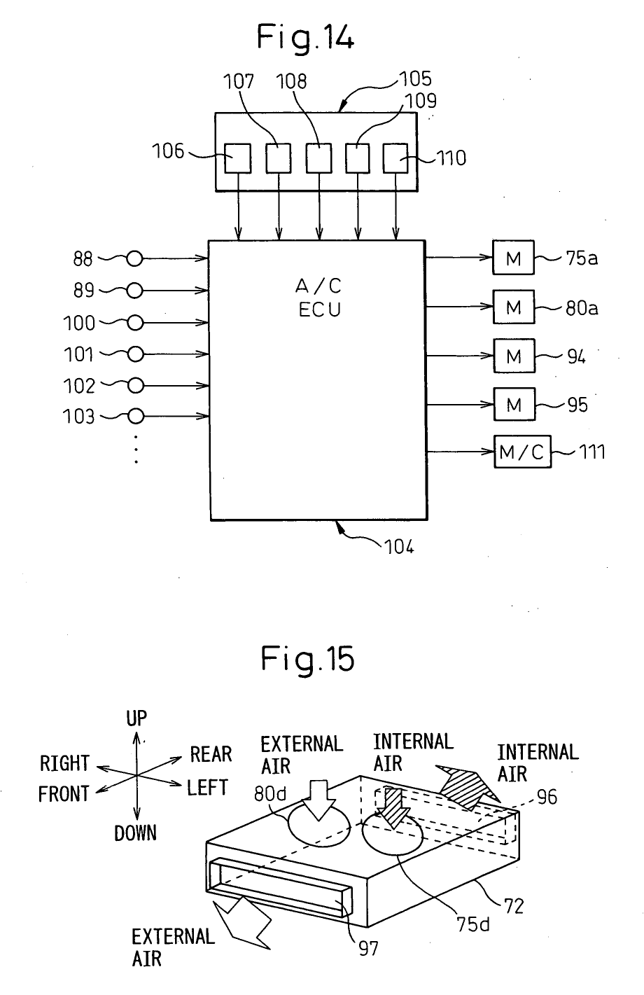

Next, an electrical control according to a sixth embodiment is briefly explained with reference to the block diagram of FIG. 14. An air-conditioning control device 104 is a control means configured of a microcomputer, etc., and the input side of the air-conditioning control device 104 is supplied with detection signals of the various sensors 88, 89, 100 to 103 described above.

Also, various operation signals are input to the air-conditioning control device 104 from an air-conditioning operation panel 105. The air-conditioning operation panel 105 is arranged on or in the neighborhood of the meter cover 19 shown in FIGS. 1, 2 and includes various operation members. Specifically, the air-conditioning operation panel 105 has mounted thereon an internal air (rear in the cabin) temperature regulation switch 106, an external air (front in the cabin) temperature regulation switch 107, an internal air (rear in the cabin) amount regulation switch 108, an external air (front in the cabin) amount regulation switch 109 and a refrigeration cycle compressor operation switch 110.

The output side of the air-conditioning control device 104 is connected with the various devices described above, or specifically, the blower drive motors 75a, 80a, the actuator mechanisms 94, 95 of the warm water valves 90, 91, the electromagnetic clutch 111 of the compressor in the refrigeration cycle, etc.

Next, the operation of the sixth embodiment is explained. Once the air amount adjusting switches 108, 109 are turned on, the drive motors 75a, 80a of the blowers 75, 80 are started by the output signal of the air-conditioning control device 104, and the blowers 75, 80 are activated. When the compressor operation switch 110 is turned on, the electromagnetic clutch 111 is energized and connected by the output signal of the air-conditioning control device 104. As a result, the compressor (not shown) in the refrigeration cycle is driven by the vehicle engine, and the refrigeration cycle is started. Thus, the cooling heat exchangers (evaporators) 78, 83 perform the cooling operation.

In the internal air-conditioning unit 73, the internal air is introduced into the air inlet 75d by the operation of the blower 75. This internal air is supplied to the internal air path 76, and through the cooling heat exchanger (evaporator) 78, cooled into a cool air.

Next, this cool air is passed through the heating heat exchanger 79. The flow rate of the warm water to the heating heat exchanger 79 is adjusted by the opening degree of the warm water valve 90, and by thus adjusting the heating capacity of the heating heat exchanger 79, the temperature of the cool air can be arbitrarily regulated. In the maximum cooling mode, the warm water valve 90 is closed up to cut off the warm water circulation to the heating heat exchanger 79. In the maximum heating mode, in contrast, the warm water valve 90 is opened full, and by thus maximizing the flow rate of the warm water to the heating heat exchanger 79, the cool water after the cooling heat exchanger 78 is heated to the maximum degree.

During the cooling operation in summer, the cool internal air cooled by the cooling heat exchanger 78 of the internal air-conditioning unit 73, after passing through the heating heat exchanger 79, is blown out toward the upper half of the passenger from the internal air outlets 98a to 98d through the internal air outlet opening 96 and the internal air outlet duct 98.

During the heating operation in winter, on the other hand, the warm air heated by the heating heat exchanger 79 of the internal air-conditioning unit 73 is blown out to the feet of the passenger from the internal air outlets 98a to 98d through the internal air outlet opening 96 and the internal air outlet duct 98.

In the external air-conditioning unit 74, on the other hand, the external air is sucked in by the operation of the blower 80, and the temperature of this external air is adjusted by heat exchange with the cooling heat exchanger 83 and the heating heat exchanger 84. The external air-conditioned air after this temperature adjustment is blown out to parts other than the passenger from the external air outlets 99a to 99d through the external air outlet opening 97 and the external air outlet duct 99. Specifically, the external air-conditioned air is blown out downward along the inner surface of the vehicle window glass from the external air outlets 99a to 99d.

As described above, the external air-conditioned air is blown into the cabin from the external air-conditioning unit 74, so that the internal pressure of the cabin is made higher than the atmospheric temperature thereby suppressing the intrusion of external dust or the like into the cabin.

The external air-conditioning unit 74 also sucks in the external air and, therefore, as compared with the internal air-conditioning unit 73 for recirculating only the air-conditioned internal air, has a larger air-conditioning heat load. As a result, the external air-conditioned air blown from the external air-conditioning unit 74 is often less comfortable for the passenger in terms of the temperature than the internal air-conditioned air blown out from the internal air-conditioning unit 73.

The external air-conditioned air from the external air-conditioning unit 74, however, is blown just downward along the inner surface of the vehicle window glass and not directly applied to the body of the passenger. As a result, the external air-conditioned air has no adverse effect on the comfort of the passenger.

In the internal air-conditioning unit 73, on the other hand, the air-conditioning heat load is so low that temperature of the internal air-conditioned air blown out can be easily approximated to the comfortable temperature for the passenger. By blowing the internal air-conditioned air toward the body of the passenger, therefore, the comfort of the passenger can be easily secured with a limited air-conditioning capacity.

In the internal air-conditioning unit 73, the air amount of the blown internal air-conditioned air can be controlled independently by controlling the rotational speed of the drive motor 75a of the blower 75 with the output signal of the control unit 104.

Also, the operation amount of the actuator mechanism 94 of the internal air-conditioning unit 73 is controlled by the output signal of the control unit 104. In this way, the opening degree of the warm water valve 90 is adjusted, and the flow rate of the warm water in the heating heat exchanger 79 can be adjusted. As a result, the heating capacity of the heating heat exchanger 79 can be controlled so that the temperature of the internal air-conditioned air blown out can be independently controlled.

In similar fashion, in the external air-conditioning unit 74, the rotational speed of the drive motor 80a of the blower 80 is controlled with the output signal of the control unit 104. In this way, the blown air amount of the external air-conditioned air can be controlled independently. Also, the operation amount of the actuator mechanism 95 of the external air-conditioning unit 74 is controlled with the output signal of the control unit 104. In this way, the flow rate of the warm water in the heating heat exchanger 84 can be regulated by adjusting the opening degree of the warm water valve 91. As a result, the heating capacity of the heating heat exchanger 84 can be controlled, thereby making it possible to control the blow-out temperature of the external air-conditioned air independently.

According to this embodiment, the longitudinal independent control operation of the blow-out air amount and blow-out temperature is automatically accomplished based on the sensor signal. Specifically, the internal air temperature of the area in the front portion and the area in the rear portion of the cabin are detected by the front and rear internal air sensors 100, 101, respectively. In the case where the internal air temperature in the front portion of the cabin is higher than that in the rear portion of the cabin during the cooling operation, for example, the opening degree of the warm water valve 91 of the external air-conditioning unit 74 is set smaller than the opening degree of the warm water valve 90 of the internal air-conditioning unit 73 by the output signal of the control unit 104.

As a result, the blow-out temperature (front blow-out temperature) of the external air-conditioned air of the external air-conditioning unit 74 can be reduced to a level lower than the blow-out temperature (rear blow-out temperature) of the internal air-conditioned air of the internal air-conditioning unit 73. In this way, the temperature distribution in the cabin can be equalized, thereby improving the driver's situation during the air-conditioning operation.

In the above-mentioned case, the rotational speed of the blower 80 of the external air-conditioning unit 74 may be set higher than that of the blower 75 of the internal air-conditioning unit 73, so that the blow-out air amount of the external air-conditioned air may be controlled to increase beyond the blow-out air amount of the internal air-conditioned air.

Further, the sunlight amount in the front and rear areas in the cabin are detected by the front and rear sunlight sensors 102, 103, respectively. During the cooling operation, for example, the sunlight amount in the front portion of the cabin may be larger than that in the rear portion of the cabin. The rotational speed of the blower 80 of the external air-conditioning unit 74 is then increased beyond that of the blower 75 of the internal air-conditioning unit 73.

As a result, the blow-out air amount (front blow-out air amount) of the external air-conditioned air can be increased beyond the blow-out air amount (rear blow-out air amount) of the internal air-conditioned air and, therefore, the thermal effect of sunlight can be obviated by the increased amount of the cool air.

In the aforementioned case, the opening degree of the warm water valve 91 of the external air-conditioning unit 74 is set smaller than that of the warm water valve 90 of the internal air-conditioning unit 73, and the blow-out temperature of the external air-conditioned air of the external air-conditioning unit 74 may be controlled to decrease to below the blow-out temperature of the internal air-conditioned air of the internal air-conditioning unit 73.

Also, in the aforementioned case, the blow-out temperature of the external air-conditioned air of the external air-conditioning unit 74 may be decreased at the same time that the blow-out air amount of the external air-conditioned air is increased. Also, the front and rear independent control operation of the blow-out air amount and the blow-out temperature described above can be performed similarly during the heating operation as well as during the cooling operation.

The foregoing description deals with an example of automatic control based on the sensor signals. However, it is natural that, based on the manual operation signals of the air amount regulation switches 106, 107 and the temperature regulation switches 108, 109 on the air-conditioning operation panel 105, the front and rear blow-out air amount and blow-out temperature can be controlled independently according to the liking of the passenger.

Also, the temperature (specifically, the fin surface temperature) of the cooling heat exchanger 78 of the internal air-conditioning unit 73 and the cooling heat exchanger 83 of the external air-conditioning unit 74 are detected by the temperature sensors 88, 89. In the case where the detection temperature on one of the temperature sensors 88, 89 is reduced to a predetermined level (about 3° C., for example) for frost prevention, the current to the electromagnetic switch 111 of the compressor is cut off and the electromagnetic clutch 111 is opened thereby to stop the compressor.

As a result, the cooling operation of the cooling heat exchangers 78, 83 providing evaporators in the refrigeration cycle is suspended, and frosting of the cooling heat exchangers 78, 83 is prevented.

Next, a seventh embodiment of the invention is explained. According to the sixth embodiment, the air inlet 75d of the internal air-conditioning unit 73 and the air inlet 80d of the external air-conditioning unit 74, as shown in FIGS. 8, 12, are arranged on the lower sides of the units 73, 74, respectively. According to the seventh embodiment, in contrast, as shown in FIG. 15, the air inlet 75d of the internal air-conditioning nit 73 and the air inlet 80d of the external air-conditioning unit 74 are both arranged on the upper surfaces of the units 73, 74, respectively.

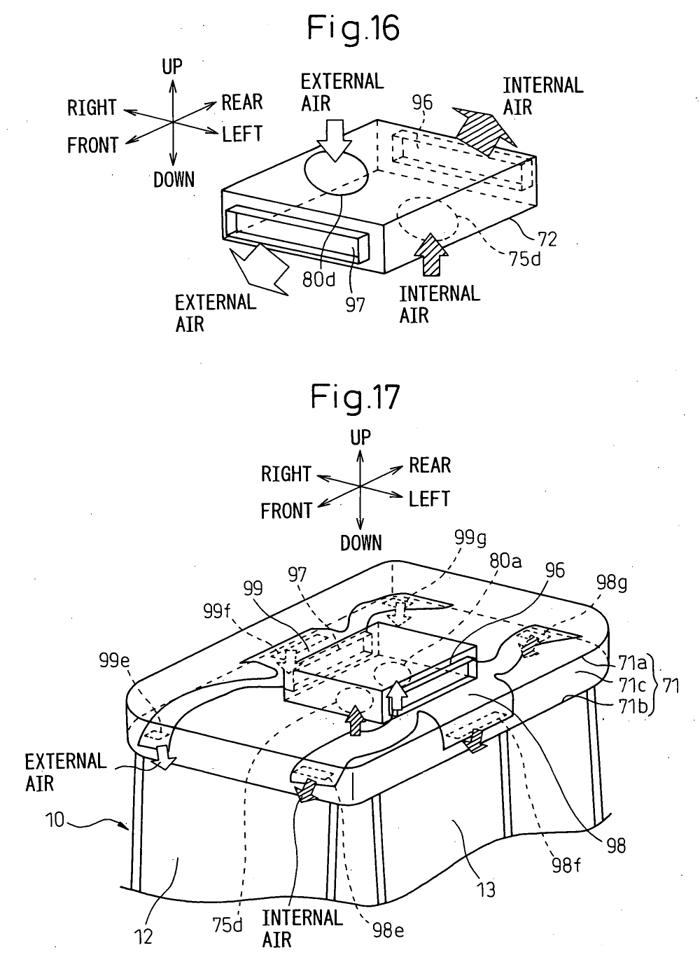

Next, an eighth embodiment is explained. According to the sixth embodiment, the air inlet 75d of the internal air-conditioning nit 73 and the air inlet 80d of the external air-conditioning unit 74, as shown in FIGS. 8, 12, are arranged on the lower surfaces of the units 73, 74, respectively. According to the eighth embodiment, in contrast, as shown in FIG. 16, the air inlet 75d of the internal air-conditioning unit 73 is arranged on the lower surface of the unit 73, while the air inlet 80d of the external air-conditioning unit 74 is arranged on the upper surface of the unit 74.

Also, in contrast with the eighth embodiment, according to another embodiment, the air inlet 75d of the internal air-conditioning unit 73 may be arranged on the upper surface of the unit 73, and the air inlet 80d of the external air-conditioning unit 74 on the lower surface of the unit 74.

As described above, the air inlets 75d, 80d of the internal air-conditioning unit 73 and the external air-conditioning unit 74 can be freely arranged on either the upper or the lower sides as desired.

Next, a ninth embodiment is explained. According to the sixth to eighth embodiments, the internal air-conditioning unit 73 and the external air-conditioning unit 74 are mounted in such positions that the internal air outlet opening 96 of the internal air-conditioning unit 73 is directed rearward of the vehicle while the external air outlet opening 97 of the external air-conditioning unit 74 is directed forward of the vehicle. According to the ninth embodiment, in contrast, as shown in FIG. 17, the internal air-conditioning unit 73 and the external air-conditioning unit 74 are mounted in such positions that the internal air outlet opening 96 of the unit 73 and the external air outlet opening 97 of the unit 74 are in opposite directions transversely of the vehicle.

In the example shown in FIG. 17, the units 73, 74 are mounted at the positions 90 degrees rotated clockwise from the positions shown in FIG. 8. Therefore, the internal air outlet opening 96 of the internal air-conditioning unit 73 is directed leftward of the vehicle, and the external air outlet opening 97 of the external air-conditioning unit 74 rightward of the vehicle.

Accordingly, the internal air outlet duct 98 connected to the internal air outlet opening 96 of the internal air-conditioning unit 73 is branched into three parts including the front, rear and longitudinally middle parts in the left side area of the vehicle. The internal air outlets 98e to 98g are set at the forward ends of the branch ducts, and the air-conditioned air is blown out toward the passenger from these internal air outlets 98e to 98g.

Also, the external air outlet duct 99 connected to the external air outlet opening 97 of the external air-conditioning unit 74 is branched into three parts including the front, rear and longitudinally middle portion in the right side area of the vehicle. The external air outlets 99e to 99g are set at the forward ends of the branch ducts, and the air-conditioned air is blown out downward from these external air outlets 99e to 99g along the inner glass surface in the right side area of the wind shield 12, the right side area of the right door window glass 13 and the rear window glass 11 of the vehicle (FIGS. 1, 2).

Also in the case where the directions in which the units 73, 74 are mounted on the vehicle are determined as described above, operational effects similar to those of the sixth embodiment can be exhibited.

According to the ninth embodiment, however, the internal air-conditioned air of the internal air-conditioning unit 73 is blown out to the left side area in the cabin and the external air-conditioned air of the external air-conditioning unit 74 to the right area in the cabin. Therefore, the blow-out temperature and the blow-out air amount on the left and right sides of the cabin can be controlled independently of each other.

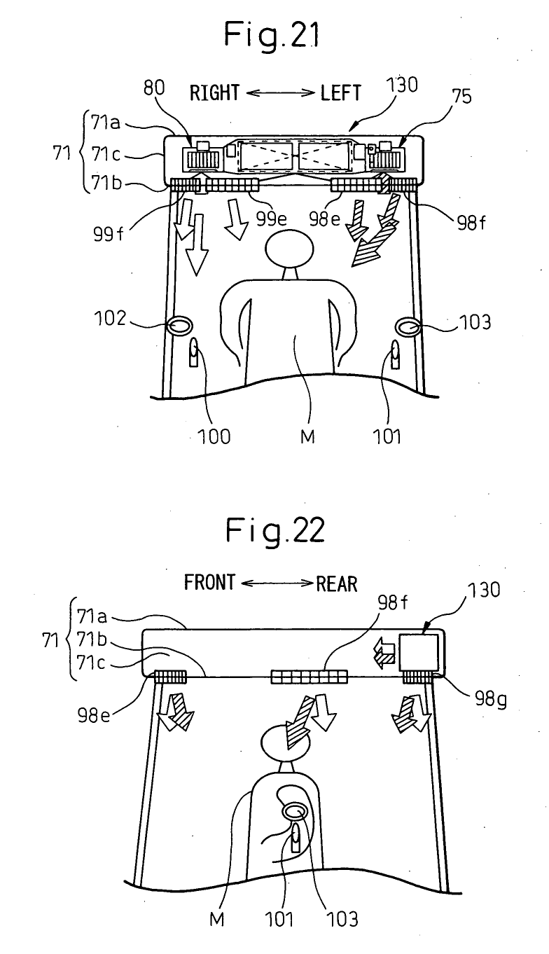

In the ninth embodiment, therefore, the internal air sensors 100, 101 and the sunlight sensors 102, 103 can be arranged on the left and right sides in the cabin as shown in FIGS. 21, 22.

Although FIG. 17 illustrates a case in which the internal air outlet opening 96 of the internal air-conditioning unit 73 is directed leftward of the vehicle, and the external air outlet opening 97 of the external air-conditioning unit 74 rightward of the vehicle. On the contrary, however, it is natural that the internal and external air-conditioning units 73, 74 may be mounted in such positions that the internal air outlet opening 96 of the internal air-conditioning unit 73 may be directed rightward of the vehicle, and the external air outlet opening 97 of the external air-conditioning unit 74 leftward of the vehicle.

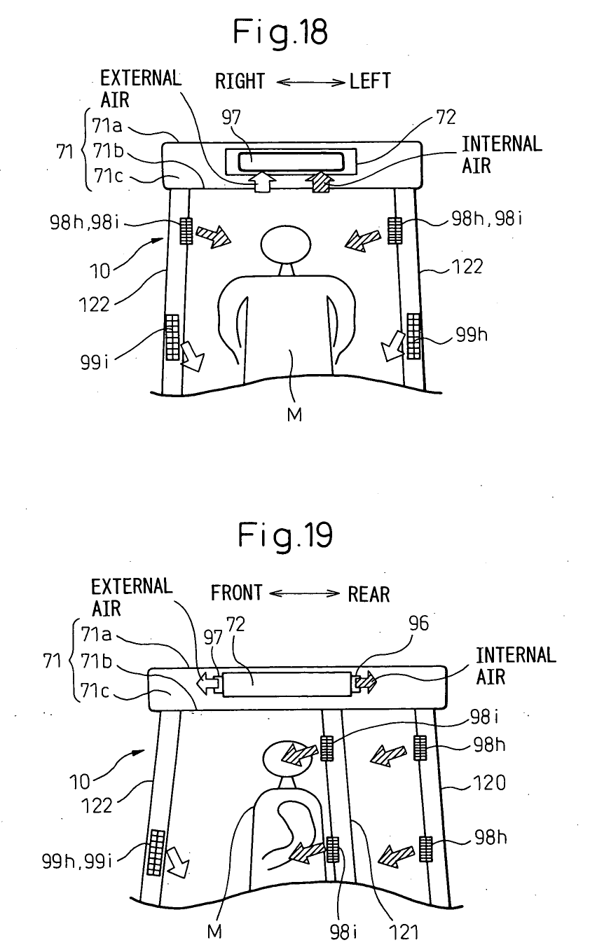

Next, a tenth embodiment is explained. In the sixth to ninth embodiments, the air outlets 98a, 99a, etc. of the units 73, 74 are all set on the roof 71. According to the tenth embodiment, on the other hand, as shown in FIGS. 18, 19, the air outlets 98h, 98i, 99h, 99i of the units 73, 74 are set on the body frame, i.e. pillars 120, 121, 122 arranged at the four corners and the longitudinal middle point of the vehicle cabin 10.

Specifically, the internal air outlets 98h, 98i are arranged at upper and lower points on each of the left and right rear pillars 120 and the left and right intermediate pillars 121 of the vehicle (eight points in total). These internal air outlets 98h, 98i are supplied with the internal air-conditioned air from the internal air-conditioning unit 73 through the internal air outlet duct 98 (not shown in FIGS. 18, 19), which is blown out toward the passenger M from the internal air outlets 98h, 98i.

Also, external air outlets 99h, 99i are arranged in the comparatively lower portion of the left and right front pillars 122. These external air outlets 99h, 99i are supplied with the external air-conditioned air from the external air-conditioning unit 74 through an external air outlet duct 99 (not shown in FIGS. 18, 19), which air is blown out toward the parts other than the passenger M from the external air outlets 99h, 99i. Specifically, the external air-conditioned air is blown out downward from the external air outlets 99h, 99i along the inner surface of the wind shield 12 or the left and right door window glass 13.

Next, an eleventh embodiment is explained. According to the sixth to tenth embodiments, the internal air-conditioning unit 73 and the external air-conditioning unit 74 are configured as independent units with the air paths thereof configured completely differently from each other. According to the eleventh embodiment, in contrast, the heat exchangers of the air-conditioning unit 73, 74 are integrated with each other, while only the blowers are independently configured.

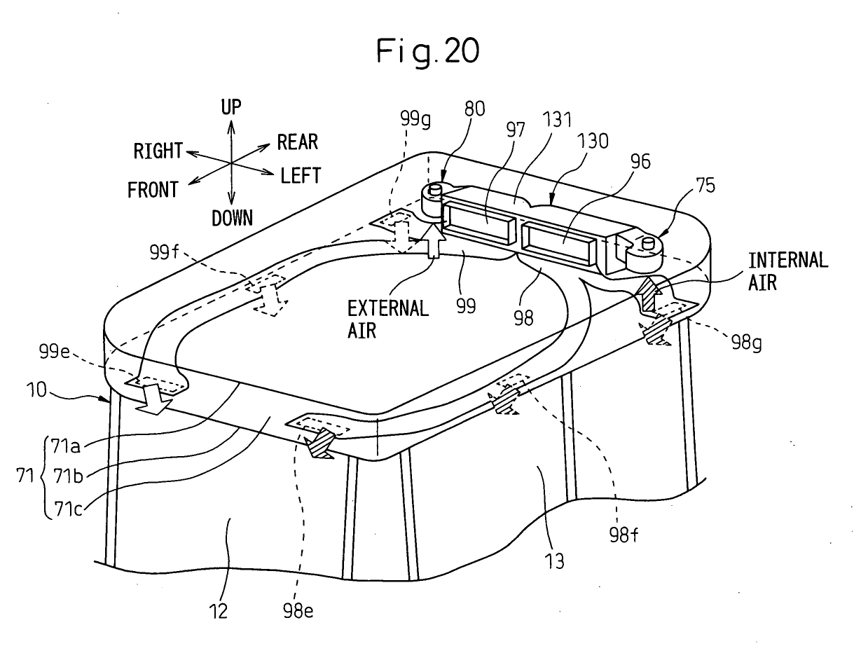

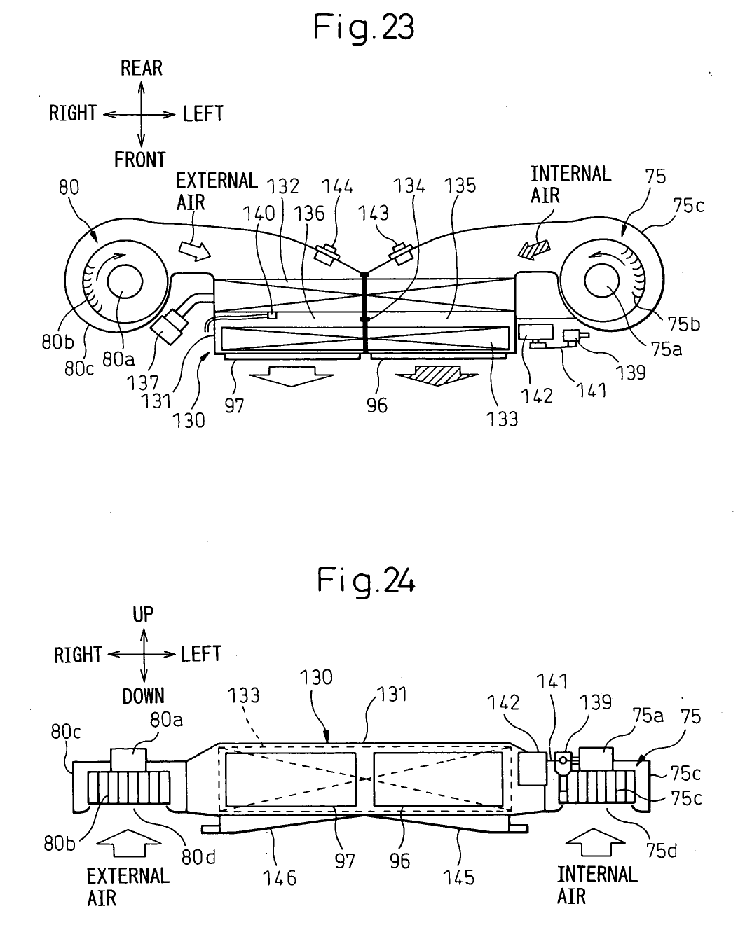

FIG. 20 is a perspective view schematically showing the upper portion of the vehicle cabin 10 according to the eleventh embodiment, FIG. 21 a front sectional view as taken from the front part of FIG. 20, and FIG. 22 a side sectional view taken transversely of FIG. 20. Further, FIG. 23 is a plan sectional view of the air-conditioning unit, and FIG. 24 a partly cutaway front view of FIG. 23.

According to the eleventh embodiment, the functions corresponding to the air-conditioning units 73, 74 according to the sixth to tenth embodiments are performed by a single air-conditioning unit 130. This air-conditioning unit 130, as shown in FIGS. 20 to 22, is arranged in elongate form extending transversely of the vehicle in the rear portion of the inner space 71c of the roof 71 of the cabin 10.

This air-conditioning unit 130 has a horizontally elongated heat exchanger case 131 extending transversely of the vehicle as shown in FIGS. 23, 24. A cooling heat exchanger 132 constituting an evaporator of the refrigeration cycle and a heating heat exchanger 133 using the engine cooling water as a heat source are arranged in the horizontally elongated case 131. The cooling heat exchanger 132 is arranged in the rear portion of the vehicle upstream in the air flow and the heating heat exchanger 133 in the front portion of the vehicle downstream in the air flow.

A partitioning plate 134 is arranged in the horizontally elongated case 131 at the transverse central portion of the vehicle thereby to partition the internal air path of the case 131 into an internal air path 135 on the left side of the vehicle and an external air path 136 on the right side of the vehicle. According to this embodiment, the partitioning plate 134 is arranged through the two heat exchangers 132, 133 from the upstream side of the cooling heat exchanger 132 to the downstream side of the heating heat exchanger 133. As a result, the tubes (refrigerant tube, warm water tube) of the heat exchangers 132, 133 are arranged over the left and right paths 135, 136 by way of the through holes of the partitioning plate 134.

The rearmost internal portion of the case 131 is located upstream of the internal air path 135 and the external air path 136. The air outlet side of the scroll case 75c of the internal air blower 75 is connected to the upstream side of the external air path 136. Also, the air outlet side of the scroll case 80c of the external air blower 80 is connected to the upstream side of the external air path 136. Thus, the blowers 75, 80 blow the air in left and right opposite directions.

The internal air blower 75 is arranged on the side of the vehicle leftward of the internal air path 135, and the external air blower 80 on the side rightward of the external air path 136. The internal air blower 75 and the external air blower 80 are thus configured symmetrically with each other about the transverse center line (partitioning plate 134) of the air-conditioning unit 130, thereby sharing part including the drive motors 75a, 80a and the fans 75b, 80b.

The cooling heat exchanger 132 and the heating heat exchanger 133 each make up a single heat exchanger structure. Therefore, the expansion valve 37 (corresponding to the expansion valves 86, 87 shown in FIG. 11) constituting a means for reducing the pressure of the refrigerant flowing into the cooling heat exchanger 132, the warm water valve 139 (corresponding to the warm water valves 90, 91 shown in FIG. 11) for adjusting the flow rate of the warm water in the heating heat exchanger 133 and the temperature sensor 140 (corresponding to the temperature sensors 88, 89 shown in FIG. 11) of the cooling heat exchanger 132 are all single in number.

The warm water valve 139 is coupled to an actuator mechanism 142 including a servo motor or the like through a link mechanism 141, and operated by the actuator mechanism 142.

According to this embodiment, a DC motor with a brush is used for the drive motors 75a, 80a of the blowers 75, 76, and the terminal voltages of the drive motors 75a, 80a are controlled by power transistors 143, 144 arranged and forcibly cooled in the outlet path of each blower.

The rotational speed of the motors 75a, 80a and hence the air amount of the blowers 75, 76 can be controlled independently of each other.

In the bottom surface of the case 131 constituting the lower portion of the cooling heat exchanger 132, drain pans 145, 146 (FIG. 24) corresponding to the internal air path 135 and the external air path 136 are arranged to collect and discharge the condensed water.

As shown in FIG. 20, an internal air outlet opening 96 making up an outlet of the internal air path 135 is arranged on the left side and an external air outlet opening 97 making up an outlet of the internal air path 136 is arranged on the right side of the case 131 at the front end portion of the vehicle. The internal air outlet opening 96 is connected with the internal air outlet duct 98, and the external air outlet opening 97 with the external air outlet duct 99.

The internal air outlet duct 98 is arranged to extend toward the front portion of the vehicle along the left side of the internal space 71c of the vehicle roof 71. The internal air outlets 98e, 98f, 98g to blow the internal air-conditioned air toward the body of the passenger M are arranged at three points of the internal air outlet duct 98 in the front portion, the longitudinal intermediate portion and rear portion of the vehicle.

The external air outlet duct 99 is arranged to extend toward the front portion of the vehicle along the right side of the internal space 71c of the vehicle roof 71. The external air outlets 99e, 99f, 99g to blow the external air-conditioned air to parts other than the body of the passenger M are arranged at three points of the external air outlet duct 99 in the front portion, the intermediate longitudinal intermediate portion and rear portion of the vehicle. Specifically, the external air outlets 99e, 99f, 99g are adapted to blow the external air just downward along the inner surface of the wind shield 12 and the door window glass 13 of the vehicle.

The internal air outlets 98e, 98f, 98g and the external air outlets 99e, 99f, 99g described above are arranged in the same positions as the corresponding air outlets according to the ninth embodiment shown in FIG. 17.

According to the eleventh embodiment, the internal air-conditioned air of the internal air-conditioning unit 73 is blown to the left side area in the cabin and the external air-conditioned air of the external air-conditioning unit 74 to the right side area in the cabin. Thus, the blow-out temperature and the blow-out air amount on the left and right sides in the cabin can be controlled independently.

According to the eleventh embodiment, therefore, the internal air sensors 100, 101 and the sunlight sensors 102, 103 are arranged on the left and right sides, respectively, in the cabin as shown in FIGS. 21, 22. This is also the case with the ninth embodiment.

In FIGS. 20 to 24, the internal air outlet opening 96 of the internal air-conditioning unit 73 is arranged on the left side of the vehicle, and the external air outlet opening 97 of the external air-conditioning unit 74 on the right side of the vehicle. On the contrary, the internal and external air-conditioning units 73, 74 may be mounted on the vehicle in such a manner that the internal air outlet opening 96 of the internal air-conditioning unit 73 is arranged on the right side of the vehicle and the external air outlet opening 97 of the external air-conditioning unit 74 on the left side of the vehicle.

The employment of the layout according to the eleventh embodiment makes possible a horizontally elongated air-conditioning unit 130 extending transversely of the vehicle as shown in FIGS. 20, 22. Therefore, the air-conditioning unit 130 can be formed thin with a small depth along the longitudinal direction of the vehicle. Thus, the air-conditioning unit 130 can be arranged at a position near to the rear small portion of the internal space 71c of the vehicle roof 71 and, therefore, the internal space 71c of the vehicle roof 71 can be effectively used for accommodating other devices.

Further, in view of the fact that the cooling heat exchanger 132 and the heating heat exchanger 133 each constitute a single heat exchanger structure, the number of parts required for the whole system can be reduced for a lower cost.

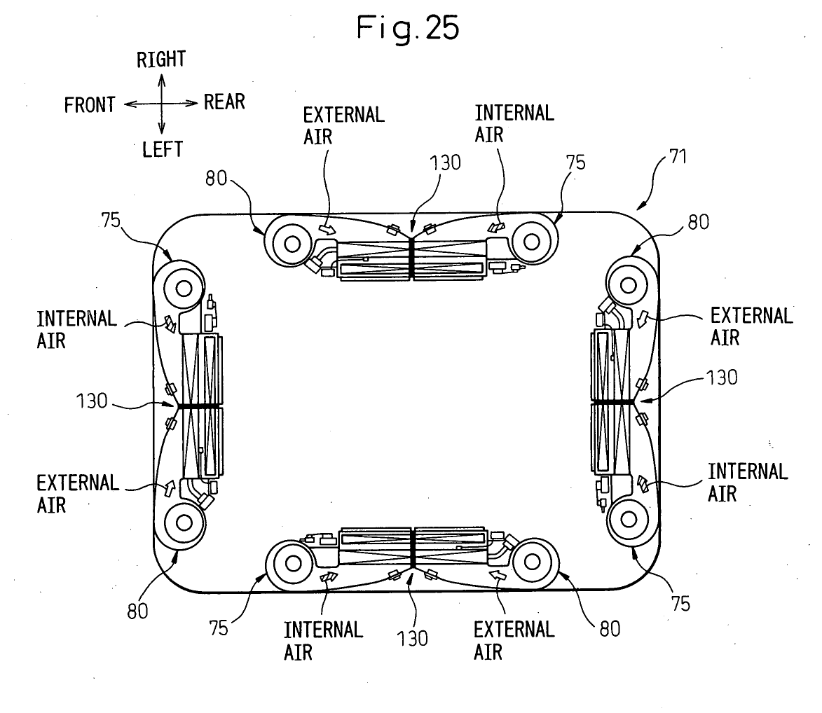

According to the eleventh embodiment described above, the air-conditioning unit 130 is arranged along the rear one of the four longitudinal and transverse sides of the vehicle roof 71. Nevertheless, the air-conditioning unit 130, which is thin and small in depth, may be arranged not along the rear side but along the front side, left side or the right side of the vehicle roof 71 as shown in FIG. 25.

In other words, the air-conditioning unit 130, taking advantage of its small thickness, can be arranged along any of the four sides of the vehicle roof 71 for an improved freedom of design.

Finally, other embodiments are explained. The air-conditioning units 73, 74, 130, arranged in the roof 71 according to the sixth to 12 embodiments, may alternatively be arranged under or behind the seat 17 (FIG. 2) with equal effect. On the contrary, the air-conditioning unit 18 according to the first to fifth embodiments may be arranged in the roof 71.

Also, in each embodiment described above, only the internal air flows through the internal air path, and only the external air flows through the external air path. As an alternative, a main internal air mixed to some degree with the external air may flow through the internal air path, while a main external air mixed to some degree with the internal air may flow through the external air path.

Specifically, the internal air flowing through the internal air path is not necessarily 100% of the internal air but may be most of the internal air mixed with some external air. In similar manner, the external air flowing through the external air path is not necessarily the external air in its entirety, but may alternatively be a main external air mixed with some internal air.

Also, according to the aforementioned embodiments in which the internal air blower 75 and the external air blower 80 are arranged independently of each other, the air amounts of the internal air blower 75 and the external air blower 80 are continuously controlled by the control output of the control unit 104. As an alternative, a switch manually operated by the passenger and a resistor with the electrical resistance thereof changeable by the switch are provided, so that by switching the resistance value of the resistor, the terminal voltages of the drive motors 75a, 80a of the two blowers 75, 80 are switched thereby to manually switch the air amounts of the blowers 75, 80 in steps.

Further, the high-temperature operating oil of a hydraulic device mounted on the vehicle such as the tractor may be used in place of the engine cooling water as a heat source of the heating heat exchanger 31.

While the invention has been described by reference to specific embodiments chosen for purposes of illustration, it should be apparent that numerous modifications could be made thereto by those skilled in the art without departing from the basic concept and scope of the invention.

1. A vehicle air conditioner comprising:
internal air paths through which an internal air flows into a cabin;
external air paths arranged in parallel to the internal air paths and through which an external air flows into the cabin;
heat exchangers arranged in at least the internal air paths to exchange heat with at least the internal air;
a blowing means for blowing the internal air in the internal air paths and the external air in the external air paths;
first air outlets for blowing the internal air after passing through the heat exchangers toward the passenger in the cabin;
second air outlets for blowing out the external air after passing through the external air paths toward parts other than the passenger and the wind shield in the cabin; and
a third air outlet for blowing the internal air after passing through the heat exchangers toward the wind shield in the cabin.

2. A vehicle air conditioner according to claim 1,
wherein the second air outlets blow out the external air toward the door window glass in the cabin.

3. A vehicle air conditioner according to claim 1,
wherein the second air outlets blow out the external air toward the floor surface in the cabin.

4. A vehicle air conditioner according to claim 1,
wherein the heat exchangers include the cooling heat exchanger for cooling the air.

5. A vehicle air conditioner comprising:
internal air paths through which an internal air flows into a cabin;
external air paths arranged in parallel to the internal air paths and through which an external air flows into the cabin;
a cooling heat exchanger arranged in at least the internal air paths to exchange heat with at least the internal air;
a blowing means for blowing the internal air of the internal air paths and the external air of the external air paths;
first air outlets for blowing the internal air after passing through the cooling heat exchanger toward the passenger in the cabin; and
second air outlets for blowing out the external air after passing through the external air paths toward the parts other than the passenger in the cabin;
wherein the blowing means is arranged downstream of the cooling heat exchanger in the air flow.

6. A vehicle air conditioner according to claim 4,
wherein the cooling heat exchanger is arranged over the whole area of the internal air paths, and
wherein the external air paths make up bypasses for the cooling heat exchanger.

7. A vehicle air conditioner according to claim 6,
wherein the cooling heat exchanger is arranged only in the internal air paths, and
wherein the whole area of the external air paths makes up the bypasses for the cooling heat exchanger.

8. A vehicle air conditioner according to claim 4,
wherein the cooling heat exchanger is arranged over the internal air paths and the external air paths.

9. A vehicle air conditioner according to claim 1,
wherein the heat exchangers include a heating heat exchanger arranged in both the internal air paths and the external air paths for heating the air.

10. A vehicle air conditioner according to claim 9,
wherein the heating heat exchanger is arranged over the entire area of the internal air paths and a part of the external air paths, and
wherein the remaining area of the external air paths makes up a bypass for the heating heat exchanger.

11. A vehicle air conditioner according to claim 9,
wherein the heating heat exchanger is arranged over the entire area of the internal air paths and over the entire area of the external air paths.

12. A vehicle air conditioner according to claim 5,
wherein the heat exchangers include a heating heat exchanger arranged in both the internal air paths and the external air paths downstream of the blowing means in the air flow.

13. A vehicle air conditioner comprising:
internal air paths through which an internal air flows into a cabin;
external air paths arranged in parallel to the internal air paths and through which an external air flows into the cabin;
heat exchangers arranged in at least the internal air paths to exchange heat with at least the internal air;
a blowing means for blowing the internal air of the internal air paths and the external air of the external air paths;
first air outlets for blowing the internal air after passing through the heat exchangers toward the passenger in the cabin; and
second air outlets for blowing out the external air after passing through the external air paths toward the parts other than the passenger in the cabin;
wherein the external air paths make up bypasses for the heat exchangers.

14. A vehicle air conditioner according to claim 1,
wherein the internal air paths are arranged at the transverse central portion of the vehicle, and
wherein the external air paths are arranged on the left and right sides of the internal air paths.

15. A vehicle air conditioner according to claim 1,
wherein an air-conditioning unit, having built therein the internal air paths, the external air paths, the heat exchangers and the blowing means, is arranged under the seat in the cabin.

16. A vehicle air conditioner comprising:
an internal air blowing means for blowing an internal air;
an external air blowing means arranged independently of the internal air blowing means for blowing an external air;
internal air paths in which the internal air blown by the internal air blowing means always flows;
external air paths in which the external air blown by the external air blowing means always flows;
heat exchangers arranged in both the internal air paths and the external air paths to exchange heat with the external air and the internal air;
first air outlets arranged at the downstream end of the internal air paths for blowing the internal air after passing through the heat exchangers toward the passenger in the cabin; and
second air outlets arranged at the downstream end of the external paths to blow the external air after passing through the heat exchangers toward the parts other than the passenger in the cabin.

17. A vehicle air conditioner according to claim 16, further comprising a control means for controlling the air amounts of the internal air blowing means and the external air blowing means independently of each other.

18. A vehicle air conditioner according to claim 16,
wherein the internal air blowing means and the external air blowing means are centrifugal blowing means, and
wherein the centrifugal internal air blowing means and the centrifugal external air blowing means are formed symmetrically with each other with the air outlets thereof arranged in directions opposite to each other, and are connected to the internal paths and the external paths, respectively.

19. A vehicle air conditioner according to claim 16,
wherein the internal air paths and the external air paths are formed in different cases independent of each other, and
wherein the heat exchangers include the internal air heat exchangers and the external air heat exchangers accommodated in the independent different cases, respectively.

20. A vehicle air conditioner according to claim 19,
wherein the internal air heat exchangers include at least an internal air heating heat exchanger for heating the air and the external air heat exchangers include at least an external air heating heat exchanger for heating the air; and
wherein the internal air heating heat exchanger and the external air heating heat exchanger include an internal air heating capacity regulation means and an external air heating capacity regulation means, respectively, independently of each other.

21. A vehicle air conditioner according to claim 16,
wherein the internal air path and the external air path are formed by being partitioned by a partitioning plate in a common case, and
wherein the heat exchangers constitute an integral structure arranged over the internal air path and the external air path in the internal space of the common case.

22. A vehicle air conditioner according to claim 16,
wherein the internal air is blown out from the first air outlets in one of the directions forward and rearward of the vehicle; and
wherein the external air is blown out from the second air outlets in the remaining one of the directions forward and rearward of the vehicle.

23. A vehicle air conditioner according to claim 16,
wherein the internal air is blown out from the first air outlets in one of the directions leftward and rightward of the vehicle, and
wherein the external air is blown out from the second air outlets in the remaining one of the directions leftward and rightward of the vehicle.

24. A vehicle air conditioner according to claim 16,
wherein air-conditioning units including the internal air blowing means, the external air blowing means, the internal air paths, the external air paths and the heat exchangers are arranged on the roof of the vehicle cabin.
